(19) United States
(12) Patent Application Publication
(10) Pub. No.: US 2023/0040263 A1
(43) Pub. Date: Feb. 9, 2023

(54) METHOD AND DEVICE USED IN COMMUNICATION NODE FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 17/950,128

(22) Filed: Sep. 22, 2022

Related U.S. Application Data
(63) Continuation of application No. PCT/CN2021/084899, filed on Apr. 1, 2021.

(30) Foreign Application Priority Data
Apr. 3, 2020 (CN) 202010257864.7
Apr. 5, 2020 (CN) 202010261849.X
Apr. 8, 2020 (CN) 202010267337.4

(51) Int. Cl. H04W 36/00; H04W 76/19

(52) U.S. Cl. CPC H04W 36/0079; H04W 76/19

(57) ABSTRACT

The present disclosure provides a method and a device in a communication node used for wireless communications. A communication node determines a failure of a radio connection with a first serving cell; and generates a first failure-related message; and executes a handover of the second serving cell; determines a failure of the handover of the second serving cell; and generates a second failure-related message; receives a first signaling; and transmits a second signaling; the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell.

### CROSS REFERENCE TO RELATED APPLICATIONS

This application is the continuation of the International Patent application No. PCT/CN2021/084899, filed on Apr. 1, 2021, which claims the priority benefit of Chinese Patent Application No. 202010257864.7, filed on Apr. 3, 2020, and claims the priority benefit of Chinese Patent Application No. 202010261849.X, filed on Apr. 5, 2020, and claims the priority benefit of Chinese Patent Application No. 202010267337.4, filed on Apr. 8, 2020, the full disclosure of which is incorporated herein by reference.

### BACKGROUND

### Technical Field

The present disclosure relates to transmission methods and devices in wireless communication systems, and in particular to a transmission method and device of Radio Link Failure report.

### Related Art

A Radio Link Failure (RLF) report of a User Equipment (UE) can be used for optimizing coverage area and mobility robustness. The UE stores information related to a latest RLF or a Handover Failure (HOF), and then indicates the RLF report's availability during each subsequent Radio Resource Control (RRC) reestablishment and inter-cell handover, and drops the information until the network acquires the RLF report or 48 hours after the RLF. Self-Organizing Networks (SON) include network self-configuration and self-optimization. A work item (WI) of New Radio (NR) SON/Minimization of Drive Tests (MDT) data collection enhancement was approved at the 3rd Generation Partnership Project (3GPP) RAN #86 to support features of SON data collection, such as mobility enhancement and optimization and handover success report, as well as support features of MDT data collection, such as 2-step Random Access Channel (RACH) optimization and RLF reporting. In a WI on NR and Long-Term Evolution (LTE) mobility enhancement, studies have been made in Release 16 to standardize Conditional Handover (CHO) and Dual Active Protocol Stack (DAPS), which is supportive of radio link recovery through CHO after an RLF occurs in the UE, as well as DAPS handover. Fast Master Cell Group (MCG) recovery was also studied in a WI of enhanced Dual Connectivity and Carrier Aggregation (eDCCA) in Release 16, in which MCG radio link recovery through a Secondary Cell Group (SCG) after an MCG RLF is supported.

### SUMMARY

According to versions before Release 16, when an RLF occurs, the UE remains RRC_CONNECTED, and shall select a cell to perform RRC Reestablishment, if there is no such appropriate cell available, the UE enters into an RRC_IDLE state. The R 16 introduces the technique of CHO, and supports radio link recovery through CHO. When a cell selected by the UE is a CHO candidate cell, the UE performs CHO procedure, otherwise the UE performs RRC Reestablishment. When an RLF occurs, the UE stores RLF-related information. After the RLF, the UE performs CHO procedures and fails, and then clears the RLF-related information and stores information related to CHO failure. Since the RLF and the CHO failure are essentially part of a same RLF-related procedure of the UE, the clear-up of RLF information will result in difficulties in determining whether the UE has undergone an RLF when the network receives an RLF report sent from the UE. If an RLF and a DAPS handover failure occurs one by one in a source cell in the procedure of DAPS handover performed by the UE, the UE will delete information related to the source cell's RLF and then store information related to DAPS handover failure. When the UE experiences two consecutive failures in a same procedure, the report on radio connection failure is required to be enhanced.

To address the above problem, the present disclosure provides a solution. In the statement above, the scenario of failure recovery through CHO after RLF is taken as an example; the present disclosure is also applicable to other scenarios, such as a procedure of DAPS handover where a UE experiences an RLF in a source cell and then a DAPS handover failure, where similar technical effects can be achieved. Additionally, the adoption of a unified solution for various scenarios contributes to the reduction of hardcore complexity and costs.

When the UE performs RRC Reestablishment, it will store a selected cell ID in an RLF-related message. However, when the UE selects a CHO candidate cell and performs CHO procedures, it recovers the radio connection failure through performing RRC Connection Reconfiguration rather than through RRC Reestablishment, at this time the UE won't store a selected cell ID, so the RLF-related message stored by the UE only comprises information about the radio connection failure that happens just now, therefore, when the UE receives an RLF report, it is incapable of determining what procedure the UE is going to perform after the radio connection failure, no matter it is entering into an IDLE state or performing CHO, which is of no good to network coverage optimization and mobility enhancement. Therefore, the report on radio link failure is required to be enhanced.

In view of the above problem, the present disclosure provides a solution. In the above statement, the scenario of failure recovery through CHO after RLF is taken as an example; the present disclosure is also applicable to scenarios such as Fast Master Cell Group (MCG) recovery after an MCG failure, where technical effects similar to those in the scenario of RLF recovery through CHO will be achieved. Additionally, the adoption of a unified solution for various scenarios contributes to the reduction of hardcore complexity and costs.

It should be noted that if no conflict is incurred, embodiments in any node in the present disclosure and the characteristics of the embodiments are also applicable to any other node, and vice versa. What's more, the embodiments in the present disclosure and the characteristics in the embodiments can be arbitrarily combined if there is no conflict.

The present disclosure provides a method in a first node for wireless communications, comprising:

determining a failure of a radio connection with a first serving cell; and generating a first failure-related message and selecting a second serving cell as a response to the determined failure of the radio connection with the first serving cell; and

executing a handover of the second serving cell;

determining a failure of the handover of the second serving cell; and generating a second failure-related message as a response to the failure of the handover of the second serving cell;

receiving a first signaling; and transmitting a second signaling;

herein, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the problem to be solved in the present disclosure includes how to generate RLF-related information if the UE is going to experience one more CHO failure given that a UE performs a link recovery through CHO after experiencing an RLF.

In one embodiment, the problem to be solved in the present disclosure includes how a UE reports RLF-related information if the UE is going to experience one more CHO failure given that a UE performs a link recovery through CHO after experiencing an RLF.

In one embodiment, the problem to be solved in the present disclosure includes how to generate RLF-related information of the UE if a source cell is going to experience a DAPS handover failure after an RLF when the UE is performing DAPS handover.

In one embodiment, the problem to be solved in the present disclosure includes how a UE reports RLF-related information if a source cell is going to experience a DAPS handover failure after an RLF when the UE is performing DAPS handover.

In one embodiment, characteristics of the above method include that after failing a CHO performed to recover an RLF that occurred, a UE stores RLF information and HOF information.

In one embodiment, characteristics of the above method include that when a UE is performing DAPS handover, if a source cell goes through an RLF and then a DAPS handover failure, the UE stores RLF information and HOF information.

In one embodiment, an advantage of the above method includes that when a connection failure occurs two times to a UE in a row, the UE will keep information related to the first connection failure.

In one embodiment, an advantage of the above method includes that a UE can send multiple RLF reports simultaneously.

In one embodiment, an advantage of the above method includes facilitating network coverage optimization.

In one embodiment, an advantage of the above method includes facilitating mobility enhancement.

In one embodiment, an advantage of the above method includes providing a more effective RLF report, thereby avoiding uncertainty of the network from uncertainty of interpreting the UE's behavior.

According to one aspect of the present disclosure, wherein the second signaling comprises the first failure-related message.

According to one aspect of the present disclosure, comprising:

transmitting a third signaling;

herein, the third signaling comprises a first message, the first message being used for indicating that the first failure-related message and the second failure-related message are generated.

According to one aspect of the present disclosure, wherein the first signaling indicates a message to be reported, and the second signaling comprises the message to be reported, the message to be reported comprising at least one of the first failure-related message or the second failure-related message.

According to one aspect of the present disclosure, comprising:

receiving a fourth signaling;

herein, the fourth signaling comprises configuration information of the second serving cell.

According to one aspect of the present disclosure, comprising:

selecting a first target cell as a response to the determined failure of the handover of the second serving cell, configuring a third field of the second failure-related message as an identity of the first target cell, and transmitting a fifth signaling;

herein, the fifth signaling is used for requesting a connection reestablishment, and the first target cell is used for the connection reestablishment.

According to one aspect of the present disclosure, comprising: clearing the first failure-related message, and the second failure-related message comprises the first failure-related message.

The present disclosure provides a method in a second node for wireless communications, comprising:

transmitting a first signaling; and

receiving a second signaling;

herein, as a response to determining a failure of the radio connection with the first serving cell, a first failure-related message is generated and the second serving cell is selected; as a response to determining a failure of a handover of the second serving cell, a second failure-related message is generated; the first signaling is transmitted after the second failure-related message is generated, the first signaling is used for triggering the second signaling, the second signaling comprising the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

According to one aspect of the present disclosure, wherein the second signaling comprises the first failure-related message.

According to one aspect of the present disclosure, comprising:

receiving a third signaling;

herein, the third signaling comprises a first message, the first message being used for indicating that the first failure-related message and the second failure-related message are generated.

According to one aspect of the present disclosure, wherein the first signaling indicates a message to be reported, and the second signaling comprises the message to be reported, the message to be reported comprising at least one of the first failure-related message or the second failure-related message.

According to one aspect of the present disclosure, wherein a fourth signaling comprises configuration information of the second serving cell, and a transmitter of the fourth signaling comprises the first serving cell.

According to one aspect of the present disclosure, comprising:

receiving a fifth signaling;

herein, the fifth signaling is used for requesting a connection reestablishment; as a response to determining the failure of the handover of the second serving cell, a first target cell is selected, and the first target cell is used for the connection reestablishment, and a third field of the second failure-related message is configured as an identity of the first target cell.

According to one aspect of the present disclosure, wherein the first failure-related message is cleared, and the second failure-related message comprises the first failure-related message.

The present disclosure provides a first node for wireless communications, comprising:

a first receiver, determining a failure of a radio connection with a first serving cell; and generating a first failure-related message and selecting a second serving cell as a response to the determined failure of the radio connection with the first serving cell; and

a first transceiver, executing a handover of the second serving cell;

the first receiver, determining a failure of the handover of the second serving cell; and generating a second failure-related message as a response to the failure of the handover of the second serving cell;

the first transceiver, receiving a first signaling; and transmitting a second signaling;

herein, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

The present disclosure provides a second node for wireless communications, comprising:

a first transmitter, transmitting a first signaling; and

a second receiver, receiving a second signaling;

herein, as a response to determining a failure of the radio connection with the first serving cell, a first failure-related message is generated and the second serving cell is selected; as a response to determining a failure of a handover of the second serving cell, a second failure-related message is generated; the first signaling is transmitted after the second failure-related message is generated, the first signaling is used for triggering the second signaling, the second signaling comprising the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the present disclosure is advantageous over the prior art in some aspects. In traditional schemes, a UE can only maintain a latest RLF-related or HOF-related information, when sending an RLF or a HOF one more time, the UE will delete previously stored RLF-related or HOF-related information. By the scheme put forward in the present disclosure,

a UE can generate and store multiple RLF-related information;

a UE can report multiple RLF reports;

when a CHO executed by a UE is failed after an RLF or a HOF occurred, the UE won't delete RLF-related or HOF-related information;

when a UE is performing DAPS handover, if a source cell firstly experiences an RLF and then a DAPS handover failure, the UE won't delete RLF-related information of the source cell;

the network coverage optimization can be facilitated;

the mobility enhancement can be facilitated.

The present disclosure provides a method in a first node for wireless communications, comprising:

receiving a first signaling, the first signaling indicating a first candidate cell set; determining a radio connection failure; and as a response to the determined radio connection failure, generating a first variant set and selecting a first target cell;

configuring a first sub-message in the first variant set as an identity of the first target cell; when the first target cell belongs to the first candidate cell set, configuring a type of the first target cell in the first variant set as a first type, and transmitting a second signaling; when the first target cell is not a candidate cell in the first candidate cell set, configuring the type of the first target cell in the first variant set as a second type, and transmitting a third signaling;

herein, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, a problem to be solved in the present disclosure includes that according to the current standards, when a UE experiences a radio connection failure and selects a CHO cell, an RLF report sent from the UE to a base station cannot reflect the UE's behavior, which means that the base station is not aware of whether the UE is in an IDLE state or performing CHO.

In one embodiment, a problem to be solved in the present disclosure includes that according to the current standards, when a UE experiences a radio connection failure and selects a CHO cell, the UE won't report an ID of the selected CHO cell.

In one embodiment, a problem to be solved in the present disclosure includes that according to the current standards, when a UE experiences a radio connection failure and performs RLF recovery, the network cannot acquire from the UE's RLF report the RLF-related information, which is not beneficial to the network coverage optimization and mobility enhancement.

In one embodiment, characteristics of the above method include that when a UE experiences a radio connection failure and selects a CHO cell, the UE stores an ID of the selected CHO cell in a VarRLF-Report.

In one embodiment, characteristics of the above method include that when a UE experiences a radio connection failure and selects a CHO cell, the UE stores a type of the selected CHO cell in a VarRLF-Report.

In one embodiment, characteristics of the above method include that when a UE experiences a radio connection failure and selects a non-CHO cell, the UE stores a type of the selected cell in a VarRLF-Report.

In one embodiment, characteristics of the above method include that when a UE experiences a radio connection failure and selects an MCG primary cell, the UE stores an ID of the MCG primary cell in a VarRLF-Report.

In one embodiment, an advantage of the above method includes facilitating network coverage optimization.

In one embodiment, an advantage of the above method includes facilitating mobility enhancement.

In one embodiment, an advantage of the above method includes providing a more effective RLF report in avoidance of the uncertainty of network interpretation of the UE's behavior.

According to one aspect of the present disclosure, wherein a name of the first sub-message in the first variant set is used to determine the type of the first target cell in the first variant set.

In one embodiment, characteristics of the above method include that the first variant set comprises the first sub-message, and a name of the first sub-message indicates a type of the first target cell.

In one embodiment, an advantage of the above method includes indicating the type of the first target cell illustratively by the name of a field or an IE.

According to one aspect of the present disclosure, wherein the first variant set comprises a second sub-message, the second sub-message being used to indicate the type of the first target cell in the first variant set.

In one embodiment, characteristics of the above method include that a first sub-message indicates a name of a first target cell, while a second sub-message indicates a type of a first target cell.

In one embodiment, an advantage of the above method includes introducing a new field or IE to indicate a type of a first target cell.

In one embodiment, an advantage of the above method includes stronger extensibility.

According to one aspect of the present disclosure, comprising:

receiving a second message; and

transmitting a third information set;

herein, the second message is used for requesting the RLF-related message; the third information set comprises a first sub-information-block, the first sub-information-block is related to the RLF-related message, and the first sub-information-block comprises a value of the first variant set.

In one embodiment, characteristics of the above method include that the first sub-information-block comprises information related to performing radio connection failure recovery after an RLF.

In one embodiment, characteristics of the above method include that the first sub-information-block comprises information related to performing CHO after an RLF.

In one embodiment, characteristics of the above method include that if a UE performs CHO after the occurrence of an RLF, when the network schedules UE information, the UE carries an ID of a CHO candidate cell selected after the RLF in an RLF report.

In one embodiment, an advantage of the above method includes facilitating network coverage optimization.

In one embodiment, an advantage of the above method includes facilitating mobility enhancement.

According to one aspect of the present disclosure, wherein when the first target cell is not a candidate cell in the first candidate cell set, comprising:

receiving a fourth signaling; and

transmitting a fifth signaling;

herein, the fourth signaling is used for triggering the fifth signaling, the fifth signaling comprising the first message.

According to one aspect of the present disclosure, wherein the first signaling comprises a first indication symbol and a first configuration, the first indication symbol being used to indicate whether the first node is allowed to apply the first configuration; the first configuration is related to the reconfiguration of the radio resource control connection.

According to one aspect of the present disclosure, wherein when the first target cell belongs to the first candidate cell set, a third sub-message in the first variant set is configured as a first condition, the first condition being used to determine conditions for application of the first configuration, and the first signaling indicates the first condition.

In one embodiment, characteristics of the above method include that if a UE performs CHO after the occurrence of an RLF, a first variant set comprises a first condition.

In one embodiment, an advantage of the above method includes providing more effective information to the network, thereby facilitating mobility enhancement.

The present disclosure provides a method in a second node for wireless communications, comprising:

configuring a first sub-message in a first variant set as an identity of a first target cell; when the first target cell belongs to a first candidate cell set, configuring a type of the first target cell in the first variant set as a first type, and receiving a second signaling; when the first target cell is not a candidate cell in the first candidate cell set, configuring a type of the first target cell in the first variant set as a second type, and receiving a third signaling;

herein, the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

According to one aspect of the present disclosure, wherein a name of the first sub-message in the first variant set is used to determine the type of the first target cell in the first variant set.

According to one aspect of the present disclosure, wherein the first variant set comprises a second sub-message, the second sub-message being used to indicate the type of the first target cell in the first variant set.

According to one aspect of the present disclosure, comprising:

transmitting a second message; and

receiving a third information set;

herein, the second message is used for requesting the RLF-related message; the third information set comprises a first sub-information-block, the first sub-information-block is related to the RLF-related message, and the first sub-information-block comprises a value of the first variant set.

According to one aspect of the present disclosure, wherein when the first target cell is not a candidate cell in the first candidate cell set, comprising:

receiving a fourth signaling; and

transmitting a fifth signaling;

herein, the fourth signaling is used for triggering the fifth signaling, the fifth signaling comprising the first message.

According to one aspect of the present disclosure, wherein the first signaling comprises a first indication symbol and a first configuration, the first indication symbol being used to indicate whether a receiver of the first signaling is allowed to apply the first configuration; the first configuration is related to the reconfiguration of the radio resource control connection.

According to one aspect of the present disclosure, wherein when the first target cell belongs to the first candidate cell set, a third sub-message in the first variant set is configured as a first condition, the first condition being used to determine conditions for application of the first configuration, and the first signaling indicates the first condition.

The present disclosure provides a first node for wireless communications, comprising:

a first receiver, which receives a first signaling, the first signaling indicating a first candidate cell set; determining a radio connection failure; and as a response to the determined radio connection failure, generating a first variant set and selecting a first target cell;

a first transmitter, which configures a first sub-message in the first variant set as an identity of the first target cell; when the first target cell belongs to the first candidate cell set, configuring a type of the first target cell in the first variant set as a first type, and transmitting a second signaling; when the first target cell is not a candidate cell in the first candidate cell set, configuring the type of the first target cell in the first variant set as a second type, and transmitting a third signaling;

herein, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

The present disclosure provides a second node for wireless communications, comprising:

a second receiver, which configures a first sub-message in a first variant set as an identity of a first target cell; when the first target cell belongs to a first candidate cell set, configuring a type of the first target cell in the first variant set as a first type, and receiving a second signaling; when the first target cell is not a candidate cell in the first candidate cell set, configuring a type of the first target cell in the first variant set as a second type, and receiving a third signaling;

herein, the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, the present disclosure is advantageous over the prior art in the following aspects:

When a UE chooses a cell after experiencing an RLF, if the chosen cell is a CHO candidate cell and the UE is configured as capable of attempting CHO after an RLF, the UE will try to perform CHO, when CHO is performed, the UE stores an ID of the chosen cell and will carry the ID of the chosen cell carried when making an RLF report;

When a UE chooses a cell after experiencing an RLF, if the chosen cell is a CHO candidate cell and the UE is configured as capable of attempting CHO after an RLF, the UE will try to perform CHO, when CHO is performed, the UE stores a CHO execution condition, and will carry the stored CHO execution condition when making an RLF report;

When a UE chooses a cell after experiencing an RLF, the UE stores the type of the chosen cell, and will carry the type of the chosen cell when making an RLF report;

Different types of cells are differentiated by different names;

Different types of cells take a same name and are differentiated by an independent field.

### BRIEF DESCRIPTION OF THE DRAWINGS

Other features, objects and advantages of the present disclosure will become more apparent from the detailed description of non-restrictive embodiments taken in conjunction with the following drawings:

FIG. 1A illustrates a flowchart of transmission of a first signaling and a second signaling according to one embodiment of the present disclosure.

FIG. 1B illustrates a flowchart of transmission of a first signaling, a second signaling and a third signaling according to one embodiment of the present disclosure.

FIG. 2 illustrates a schematic diagram of a network architecture according to one embodiment of the present disclosure.

FIG. 3 illustrates a schematic diagram of a radio protocol architecture of a user plane and a control plane according to one embodiment of the present disclosure.

FIG. 4 illustrates a schematic diagram of a first communication device and a second communication device according to one embodiment of the present disclosure.

FIG. 5A illustrates a flowchart of radio signal transmission according to one embodiment of the present disclosure.

FIG. 5B illustrates a flowchart of radio signal transmission according to one embodiment of the present disclosure.

FIG. 6A illustrates a schematic diagram of a first failure-related message and a second failure-related message being generated and transmitted according to one embodiment of the present disclosure.

FIG. 6B illustrates a schematic diagram of transmission of a second message and a third information set according to one embodiment of the present disclosure.

FIG. 7A illustrates a schematic diagram of a first failure-related message and a second failure-related message being generated and transmitted according to another embodiment of the present disclosure.

FIG. 7B illustrates a schematic diagram of a procedure of a first variant set being configured according to one embodiment of the present disclosure.

FIG. 8A illustrates a schematic diagram of a first message of a third signaling being used to indicate generation of a first failure-related message and a second failure-related message according to one embodiment of the present disclosure.

FIG. 8B illustrates a schematic diagram of a name of a first sub-message in a first variant set being used to determine a type of a first target cell in a first variant set according to one embodiment of the present disclosure.

FIG. 9A illustrates a schematic diagram of a first message of a third signaling being used to indicate generation of a first failure-related message and a second failure-related message according to another embodiment of the present disclosure.

FIG. 9B illustrates a schematic diagram of a second sub-message being used to indicate a type of a first target cell in a first variant set according to one embodiment of the present disclosure.

FIG. 10A illustrates a schematic diagram of a first message of a third signaling being used to indicate generation of a first failure-related message and a second failure-related message according to another embodiment of the present disclosure.

FIG. 10B illustrates a schematic diagram of a first sub-information-block comprising a first condition according to one embodiment of the present disclosure.

FIG. 11A illustrates a schematic diagram of a first message of a third signaling being used to indicate generation of a first failure-related message and a second failure-related message according to another embodiment of the present disclosure.

FIG. 11B illustrates a schematic diagram of a first signaling comprising a first indication symbol and a first configuration according to one embodiment of the present disclosure.

FIG. 12A illustrates a schematic diagram of a second signaling comprising a first failure-related message and a second failure-related message according to one embodiment of the present disclosure.

FIG. 12B illustrates a schematic diagram of a first variant set comprising a first condition according to one embodiment of the present disclosure.

FIG. 13A illustrates a schematic diagram of a second signaling comprising a first failure-related message and a second failure-related message according to another embodiment of the present disclosure.

FIG. 13B illustrates a schematic diagram of a set of values of a second sub-message comprising K types according to one embodiment of the present disclosure.

FIG. 14A illustrates a structure block diagram of a processing device in a first node according to one embodiment of the present disclosure.

FIG. 14B illustrates a structure block diagram of a processing device in first second node according to one embodiment of the present disclosure.

FIG. 15A illustrates a structure block diagram of a processing device in a second node according to one embodiment of the present disclosure.

FIG. 15B illustrates a structure block diagram of a processing device in a second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1A

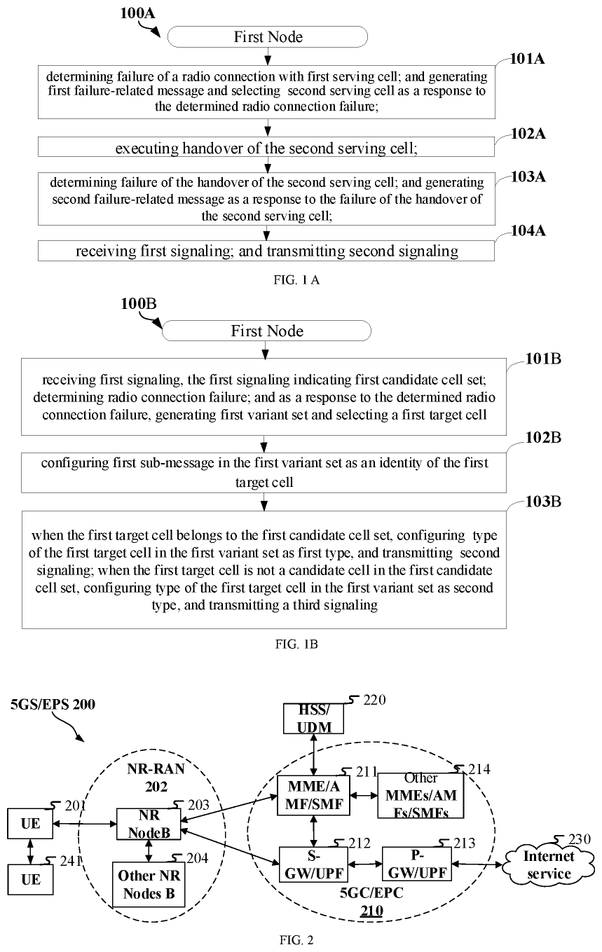

Embodiment 1A illustrates a flowchart of transmission of a first signaling and a second signaling according to one embodiment of the present disclosure, as shown in FIG. 1A. In FIG. 1A, each box represents a step. It should be noted particularly that the order in which the boxes are arranged does not imply a chronological sequence of each step respectively marked.

In Embodiment 1A, the first node in the present disclosure determines a failure of a radio connection with a first serving cell in step 101A; and generates a first failure-related message and selects a second serving cell as a response to the determined failure of the radio connection with the first serving cell; and executes a handover of the second serving cell in step 102A; determines a failure of the handover of the second serving cell in step 103A; and generates a second failure-related message as a response to the failure of the handover of the second serving cell; receives a first signaling in step 104A; and transmits a second signaling; herein, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the first receiver determines the failure of a radio connection with the first serving cell.

In one embodiment, the first node determines the failure of a radio connection with the first serving cell.

In one embodiment, the first receiver determines the failure of the handover of the second serving cell.

In one embodiment, the first node determines the failure of the handover of the second serving cell.

In one embodiment, the first serving cell comprises a Source Cell.

In one embodiment, the first serving cell comprises a Primary Cell (PCell).

In one embodiment, the second serving cell comprises a Target Cell.

In one embodiment, the second serving cell comprises a CHO Candidate.

In one embodiment, the first serving cell and the second serving cell belong to a same Public land mobile network (PLMN).

In one subembodiment, a Radio Access Technology (RAT) adopted by the PLMN comprises New Radio (NR).

In one subembodiment, a Radio Access Technology (RAT) adopted by the PLMN comprises LTE.

In one embodiment, the phrase of determining the failure of a radio connection with the first serving cell includes: the first node determines that an RLF occurs between the first node and the first serving cell.

In one subembodiment, when a Timer T310 is expired, the first node determines the RLF occurs between the first node and the first serving cell.

In one subembodiment, when a Timer T312 is expired, the first node determines the RLF occurs between the first node and the first serving cell.

In one subembodiment, when an indication of reaching a maximum number of retransmissions is received from Master Cell Group (MCG) Radio Link Control (RLC), it is determined that the radio link with the first serving cell is failed.

In one subembodiment, when an indication of reaching a maximum number of retransmissions of a Signaling Radio Bearer (SRB) or a Data Radio Bearer (DRB) is received from MCG RLC, it is determined that the radio link with the first serving cell is failed.

In one subembodiment, when receiving an indication of an issue of random access from MCG Medium Access Control (MAC), and none of the timers T300, T301, T304, T311 and T319 is running, it is determined that the radio link with the first serving cell is failed.

In one subembodiment, when receiving an indication of an issue of random access from MCG

MAC, and none of the timers T300, T301, T304 and T311 is running, it is determined that the radio link with the first serving cell is failed.

In one embodiment, the phrase that it is determined that the radio link with the first serving cell is failed includes determining a Handover Failure (HOF).

In one subembodiment, when the timer T304 is expired, it is determined that the HOF occurs.

In one embodiment, the handover includes conventional handover.

In one embodiment, the handover includes CHO.

In one embodiment, the handover includes DAPS.

In one embodiment, when the radio connection failure occurs, the first node is performing the handover.

In one embodiment, when the radio connection failure occurs, the first node is not performing the handover.

In one embodiment, when the timer T304 is running, the radio connection failure occurs.

In one embodiment, when the timer T304 is not running, the radio connection failure occurs.

In one embodiment, the first failure-related message is stored in a variant.

In one embodiment, the first failure-related message is stored in a variant set.

In one embodiment, the first failure-related message is stored in a VarRLF-Report.

In one embodiment, as a response to the determined failure of the radio connection with the first serving cell, a message related to the radio connection failure is stored in a VarRLF-Report, thus generating the first failure-related message.

In one subembodiment, the first failure-related message comprises all contents in a VarRLF-Report.

In one subembodiment, the first failure-related message comprises some contents in a VarRLF-Report.

In one embodiment, the phrase of generating a first failure-related message and selects a second serving cell as a response to the determined failure of the radio connection with the first serving cell includes generating a first failure-related message and selecting a second serving cell when the radio connection failure between the first node and the first serving cell is determined.

In one embodiment, the phrase of generating a first failure-related message and selects a second serving cell as a response to the determined failure of the radio connection with the first serving cell includes generating a first failure-related message and selecting a second serving cell when the first node declares that the radio connection failure occurred.

In one embodiment, the phrase of generating a first failure-related message includes storing the first failure-related message.

In one embodiment, the phrase of generating a first failure-related message includes saving the first failure-related message.

In one embodiment, the phrase of generating a first failure-related message includes setting the first failure-related message.

In one embodiment, the phrase of generating a first failure-related message includes logging the first failure-related message.

In one embodiment, the first failure-related message comprises a result of measurement on the first serving cell.

In one embodiment, the first failure-related message comprises a result of measurement on a neighboring cell of the first serving cell.

In one subembodiment, the neighboring cell includes an LTE cell.

In one subembodiment, the neighboring cell includes an NR cell.

In one embodiment, the first failure-related message comprises a type of connection failure.

In one embodiment, the first failure-related message comprises a cause of connection failure.

In one subembodiment, the cause of the connection failure comprises foundations of determining a failure of a radio connection with a first serving cell.

In one subembodiment, the cause of the connection failure comprises t310-Expiry.

In one subembodiment, the cause of the connection failure comprises t312-Expiry.

In one subembodiment, the cause of the connection failure comprises randomAccessProblem.

In one subembodiment, the cause of the connection failure comprises rlc-MaxNumRetx.

In one subembodiment, the cause of the connection failure comprises beamFailureRecoveryFailure.

In one embodiment, the first failure-related message comprises an identity of the first serving cell.

In one embodiment, the first failure-related message comprises an identity of the second serving cell.

In one embodiment, the first failure-related message comprises a message related to the radio connection failure.

In one embodiment, the first failure-related message comprises a VarRLF-Report.

In one embodiment, the first failure-related message comprises all information stored in a VarRLF-Report.

In one embodiment, the first failure-related message comprises part of information stored in a VarRLF-Report.

In one embodiment, the first failure-related message comprises a measResultLastServCell.

In one embodiment, the first failure-related message comprises measResultNeighCells.

In one embodiment, the first failure-related message comprises a measResultListNR.

In one embodiment, the first failure-related message comprises a measResultListEUTRA.

In one embodiment, the first failure-related message comprises a connectionFailureType.

In one embodiment, the first failure-related message comprises a rlf-Cause.

In one embodiment, the first failure-related message comprises a previousPCellId.

In one embodiment, the first failure-related message comprises a failedPCellId.

In one embodiment, the phrase of selecting a second serving cell includes determining the second serving cell.

In one embodiment, the phrase of selecting a second serving cell includes executing a procedure of cell selection, and a cell selected through the procedure of cell selection is the second serving cell.

In one embodiment, the second serving cell includes a CHO candidate cell.

In one embodiment, the second serving cell includes a target cell of the hand over.

In one embodiment, the phrase of executing a handover of the second serving cell includes performing Radio Resource Control (RRC) Connection Reconfiguration for the second serving cell.

In one embodiment, the phrase of executing a handover of the second serving cell includes performing Radio Resource Control (RRC) Connection Reestablishment for the second serving cell.

In one embodiment, the phrase of executing a handover of the second serving cell includes monitoring RRC connection establishment.

In one embodiment, the phrase of executing a handover of the second serving cell includes acquiring uplink synchronization with the second serving cell.

In one embodiment, the phrase of executing a handover of the second serving cell includes applying RRC configurations of the second serving cell.

In one embodiment, the phrase of executing a handover of the second serving cell includes initiating RRC connection Establishment for the second serving cell.

In one embodiment, the phrase of executing a handover of the second serving cell includes initiating a random access procedure.

In one subembodiment, the random access procedure comprises 4-step random access.

In one subembodiment, the random access procedure comprises 2-step random access.

In one embodiment, the phrase of executing a handover of the second serving cell includes transmitting an RRC connection establishment request.

In one embodiment, the phrase of executing a handover of the second serving cell includes transmitting a message (msg)1 and a msg3.

In one embodiment, the phrase of executing a handover of the second serving cell includes transmitting a msgA.

In one embodiment, the phrase of executing a handover of the second serving cell includes receiving a msgB.

In one embodiment, the phrase of executing a handover of the second serving cell includes transmitting a msg1.

In one embodiment, the phrase of executing a handover of the second serving cell includes receiving a msg2.

In one embodiment, the phrase of executing a handover of the second serving cell includes transmitting a msg3.

In one embodiment, the phrase of executing a handover of the second serving cell includes receiving a msg4.

In one embodiment, when performing the handover for the second serving cell, the first node leaves the first serving cell and is synchronized to the second serving cell.

In one embodiment, when performing the handover for the second serving cell, the first node does not leave the first serving cell and is synchronized to the second serving cell.

In one subembodiment, the phrase that “does not leave” includes not releasing SRB resources of the first serving cell.

In one subembodiment, the phrase that “does not leave” includes retaining RRC configuration information of the first serving cell.

In one embodiment, the phrase of determining the failure of the handover of the second serving cell includes determining the occurrence of an RLF of the second serving cell.

In one embodiment, the phrase of determining the failure of the handover of the second serving cell includes determining the occurrence of a HOF of the second serving cell.

In one embodiment, the phrase of determining the failure of the handover of the second serving cell includes a failure in a random access procedure initiated on the second serving cell.

In one embodiment, the phrase of determining the failure of the handover of the second serving cell includes no response is made to an RRC connection establishment initiated on the second serving cell.

In one embodiment, the phrase of determining the failure of the handover of the second serving cell includes that a first timer is expired.

In one subembodiment, the first timer comprises a T304, when the timer T304 is expired, the first node determines the occurrence of a HOF of the second serving cell.

In one embodiment, the second failure-related message is stored in a variant.

In one embodiment, the second failure-related message is stored in a variant set.

In one embodiment, the second failure-related message is stored in a VarRLF-Report.

In one embodiment, when the second failure-related message is generated, the first failure-related message is cleared.

In one embodiment, when the second failure-related message is generated, the first failure-related message is not cleared.

In one embodiment, as a response to the determined failure of the handover of the second serving cell, the message related to the radio connection failure is stored in a VarRLF-Report, thus generating the second failure-related message.

In one subembodiment, the second failure-related message comprises all contents in a VarRLF-Report.

In one subembodiment, the second failure-related message comprises some contents in a VarRLF-Report.

In one embodiment, the phrase of generating a second failure-related message as a response to the failure of the handover of the second serving cell includes that when the failure of the handover of the second serving cell is determined, the second failure-related message is generated.

In one embodiment, the phrase that as a response to the failure of the handover of the second serving cell includes that when the timer T304 is expired, the second failure-related message is generated.

In one embodiment, the phrase that the second failure-related message is generated includes storing the second failure-related message.

In one embodiment, the phrase that the second failure-related message is generated includes saving the second failure-related message.

In one embodiment, the phrase that the second failure-related message is generated includes setting the second failure-related message.

In one embodiment, the phrase that the second failure-related message is generated includes logging the second failure-related message.

In one embodiment, the second failure-related message is used for storing a message related to the failure of the handover of the second serving cell.

In one embodiment, the second failure-related message comprises a VarRLF-Report.

In one embodiment, the second failure-related message comprises information stored in a VarRLF-Report.

In one embodiment, the second failure-related message comprises all contents in a VarRLF-Report.

In one embodiment, the second failure-related message comprises some contents in a VarRLF-Report.

In one embodiment, the second failure-related message comprises a result of a measurement on the first serving cell.

In one embodiment, the second failure-related message comprises a result of a measurement on a neighboring cell of the first serving cell.

In one subembodiment, the neighboring cell includes an LTE cell.

In one subembodiment, the neighboring cell includes an NR cell.

In one embodiment, the second failure-related message comprises a type of connection failure.

In one embodiment, the second failure-related message comprises a cause of connection failure.

In one subembodiment, the cause of the connection failure comprises foundations of determining a failure of a radio connection with a second serving cell.

In one subembodiment, the cause of the connection failure comprises t310-Expiry.

In one subembodiment, the cause of the connection failure comprises t312-Expiry.

In one subembodiment, the cause of the connection failure comprises randomAccessProblem.

In one subembodiment, the cause of the connection failure comprises rlc-MaxNumRetx.

In one subembodiment, the cause of the connection failure comprises beamFailureRecoveryFailure.

In one subembodiment, the cause of the connection failure comprises T304-Expiry.

In one embodiment, the second failure-related message comprises an identity of the first serving cell.

In one embodiment, the second failure-related message comprises an identity of the second serving cell.

In one embodiment, the second failure-related message comprises a message related to the radio connection failure.

In one embodiment, the second failure-related message comprises a VarRLF-Report.

In one embodiment, the second failure-related message comprises information stored in a VarRLF-Report.

In one embodiment, the second failure-related message comprises all contents in a VarRLF-Report.

In one embodiment, the second failure-related message comprises some contents in a VarRLF-Report.

In one embodiment, the second failure-related message comprises a measResultLastServCell.

In one embodiment, the second failure-related message comprises measResultNeighCells.

In one embodiment, the second failure-related message comprises a measResultListNR.

In one embodiment, the second failure-related message comprises a measResultListEUTRA.

In one embodiment, the second failure-related message comprises a connectionFailureType.

In one embodiment, the second failure-related message comprises a rlf-Cause.

In one embodiment, the second failure-related message comprises a previousPCellId.

In one embodiment, the second failure-related message comprises a failedPCellId.

In one embodiment, a transmitter of the first signaling comprises a maintenance base station for the first serving cell.

In one embodiment, a transmitter of the first signaling comprises a maintenance base station for a current serving cell of the first node.

In one embodiment, the first signaling is transmitted via an air interface.

In one embodiment, the first signaling is transmitted via a wireless interface.

In one embodiment, the first signaling is transmitted via a higher layer signaling.

In one embodiment, the first signaling comprises a higher layer signaling.

In one embodiment, the first signaling comprises all or part of a higher layer signaling.

In one embodiment, the first signaling comprises an RRC message.

In one embodiment, the first signaling comprises all or part of IEs in an RRC message.

In one embodiment, the first signaling comprises all or part of fields of an IE in an RRC message.

In one embodiment, the first signaling comprises a Downlink (DL) signaling.

In one embodiment, a Signaling Radio Bearer of the first signaling includes SRB1.

In one embodiment, a logical channel bearing the first signaling includes a Dedicated Control Channel (DCCH).

In one embodiment, the first signaling is used for triggering transmission of the second signaling.

In one embodiment, the first signaling is used for requesting UE Information.

In one embodiment, the first signaling is used for requesting RLF-related information.

In one embodiment, the first signaling is used for determining a request for the RLF recovery-related information.

In one embodiment, the first signaling is used for determining a request for a message related to successful handover.

In one embodiment, the first signaling comprises a UEInformationRequest message.

In one embodiment, the first signaling comprises an RLF-ReportReq IE.

In one embodiment, the first signaling comprises a rlf-ReportReq field.

In one embodiment, the first signaling comprises a successHandover-ReportReq field.

In one embodiment, the first signaling comprises a rlfRecovery-ReportReq field.

In one embodiment, the phrase that the first signaling is received after generating the second failure-related message includes that when the second failure-related message is generated, the first signaling is received.

In one embodiment, the phrase that the first signaling is received after generating the second failure-related message includes that when the first node determines a failure of the radio connection with the first serving cell and a failure of the handover of the second serving cell, the first signaling is received.

In one embodiment, the phrase that the first signaling is used for triggering the second signaling includes transmitting the second signaling as a response to receiving the first signaling.

In one embodiment, the phrase that the first signaling is used for triggering the second signaling includes that the first signaling is used for acknowledging for the second signaling.

In one embodiment, the phrase that the first signaling is used for triggering the second signaling includes that the second signaling is a response to the first signaling.

In one embodiment, a receiver of the second signaling is the same as a transmitter of the first signaling.

In one embodiment, the second signaling is transmitted via an air interface.

In one embodiment, the second signaling is transmitted via a wireless interface.

In one embodiment, the second signaling is transmitted via a higher layer signaling.

In one embodiment, the second signaling comprises a higher layer signaling.

In one embodiment, the second signaling comprises all or part of a higher layer signaling.

In one embodiment, the second signaling comprises an RRC message.

In one embodiment, the second signaling comprises all or part of IEs in an RRC message.

In one embodiment, the second signaling comprises all or part of fields of an IE in an RRC message.

In one embodiment, the second signaling comprises an Uplink (UL) signaling.

In one embodiment, the second signaling is used for UE Information response.

In one embodiment, the second signaling is used for reporting an RLF-related message.

In one embodiment, a Signaling Radio Bearer of the second signaling includes SRB1.

In one embodiment, a Signaling Radio Bearer of the second signaling includes SRB2.

In one embodiment, a logical channel bearing the second signaling includes a DCCH.

In one embodiment, the second signaling comprises a UEInformationResponse message.

In one embodiment, the second signaling comprises information stored in a VarRLF-Report.

In one embodiment, the second signaling comprises an RLF-Report field.

In one embodiment, the second signaling comprises an nr-RLF-Report field.

In one embodiment, the second signaling comprises a eutra-RLF-Report field.

In one embodiment, the second signaling comprises a rlf-Report field.

In one embodiment, the first signaling comprises a successHandover-Report field.

In one embodiment, the first signaling comprises a rlfRecovery-Report field.

In one embodiment, the second signaling comprises a FailureInformation message.

In one embodiment, the second signaling comprises a FailureInfoDAPS IE.

In one embodiment, the second signaling comprises a failureInfoDAPS field.

In one embodiment, the phrase that the second signaling comprises the second failure-related message includes that the second failure-related message comprises one or more fields of the second signaling.

In one embodiment, the phrase that the second signaling comprises the second failure-related message includes that the second failure-related message comprises one or more IEs in the second signaling.

In one embodiment, the second signaling is used for indicating the second failure-related message.

In one embodiment, the second signaling is used for determining the second failure-related message.

In one embodiment, the second signaling comprises all of the second failure-related message.

In one embodiment, the second signaling comprises part of the second failure-related message.

In one embodiment, the phrase that the first failure-related message comprises a first field includes that the first field is a field in the first failure-related message.

In one embodiment, the phrase that the first failure-related message comprises a first field includes that the first failure-related message is used for determining the first field.

In one embodiment, the phrase that the first field comprised by the first failure-related message comprises an identity of the first serving cell includes that the first field comprised by the first failure-related message is used for determining a cell ID of the first serving cell.

In one embodiment, the phrase that the first field comprised by the first failure-related message comprises an identity of the first serving cell includes that the first field comprised by the first failure-related message is used for indicating a cell ID of the first serving cell.

In one embodiment, the phrase that the first field comprised by the first failure-related message comprises an identity of the first serving cell includes that the first field comprised by the first failure-related message is configured as a cell ID of the first serving cell.

In one embodiment, the first field comprised by the first failure-related message comprises a field in a VarRLF-Report.

In one subembodiment, the VarRLF-Report comprises an nr-RLF-Report.

In one subembodiment, the VarRLF-Report comprises a eutra-RLF-Report.

In one embodiment, the first field comprised by the first failure-related message comprises a field in an RLF-Report.

In one embodiment, the first field comprised by the first failure-related message comprises a field in a UEInformationResponse.

In one embodiment, the first field comprised by the first failure-related message is used for indicating a Source PCell during a last handover, the Source PCell comprising the first serving cell.

In one embodiment, the first field comprised by the first failure-related message comprises a Cell Identity (Cell ID).

In one embodiment, the Cell Identity comprises a Physical Cell Identity (PCI).

In one embodiment, the Cell Identity comprises a Global Cell Identity (CGI).

In one embodiment, the Cell Identity comprises an Evolved Global Cell Identity (ECGI).

In one embodiment, the Cell Identity comprises a Tracking Area Code (TAC).

In one embodiment, the Cell Identity comprises a CGI-Info-LoggingDetailed.

In one embodiment, the Cell Identity comprises a CGI-Info-Logging.

In one embodiment, the Cell Identity comprises a CGI-Info-LoggingDetailed.

In one embodiment, the Cell Identity comprises a PhysCellId.

In one embodiment, the Cell Identity comprises an ARFCN-ValueNR.

In one embodiment, the Cell Identity comprises a plmn-Identity.

In one embodiment, the Cell Identity comprises a cellIdentity.

In one embodiment, the first field comprised by the first failure-related message comprises a PLMN.

In one embodiment, the first field comprised by the first failure-related message comprises a previousPCellId.

In one embodiment, the first field comprised by the first failure-related message comprises a failedPCellId.

In one embodiment, the first field comprised by the first failure-related message comprises a cellGlobalId.

In one embodiment, the first field comprised by the first failure-related message comprises a pci-arfcn.

In one embodiment, the first field comprised by the first failure-related message comprises a physCellId.

In one embodiment, the first field comprised by the first failure-related message comprises a carrierFreq.

In one embodiment, the first field comprised by the first failure-related message comprises a previousPCellId.

In one embodiment, the first field comprised by the first failure-related message comprises a failedPCellId.

In one embodiment, when the first type includes rlf, the first field comprised by the first failure-related message comprises a failedPCellId, and the failedPCellId is used for indicating an identity of the first serving cell.

In one subembodiment, a second field of the first failure-related message comprises a previousPCellId, and the previousPCellId is used for indicating a cell ID of a target cell during a last handover.

In one embodiment, when the first type includes hof, the first field comprises a previousPCellId, and the previousPCellId is used for indicating an identity of the first serving cell.

In one subembodiment, a second field of the first failure-related message comprises a failedPCellId, and the failedPCellId is used for indicating an identity of the second serving cell.

In one embodiment, the phrase that a second field of the second failure-related message comprises an identity of the first serving cell includes that the second field of the second failure-related message is used for determining the identity of the first serving cell.

In one embodiment, the phrase that a second field of the second failure-related message comprises an identity of the first serving cell includes that the second field of the second failure-related message is used for indicating the identity of the first serving cell.

In one embodiment, the phrase that a second field of the second failure-related message comprises an identity of the first serving cell includes that the second field of the second failure-related message is configured as the identity of the first serving cell.

In one embodiment, the second field of the second failure-related message comprises a field in a VarRLF-Report.

In one embodiment, the second field of the second failure-related message comprises a field in an RLF-Report.

In one embodiment, the second field of the second failure-related message comprises a field in a UEInformationResponse.

In one embodiment, the second field of the second failure-related message is used for indicating a Source PCell during a last handover.

In one subembodiment, the Source PCell comprises the first serving cell.

In one embodiment, the second field of the second failure-related message comprises a Cell ID.

In one embodiment, the second field of the second failure-related message comprises a TAC.

In one embodiment, the second field of the second failure-related message comprises a PLMN.

In one embodiment, the second field of the second failure-related message comprises a previousPCellId.

In one embodiment, the second field of the second failure-related message comprises a failedPCellId.

In one embodiment, the second field of the second failure-related message comprises a cellGlobalId.

In one embodiment, the second field of the second failure-related message comprises a pci-arfcn.

In one embodiment, the second field of the second failure-related message comprises a physCellId.

In one embodiment, the second field of the second failure-related message comprises a carrierFreq.

In one embodiment, the second failure-related message comprises a result of a measurement on the first serving cell.

In one embodiment, the second failure-related message comprises a result of a measurement on a neighboring cell of the first serving cell.

In one subembodiment, the neighboring cell includes an LTE cell.

In one subembodiment, the neighboring cell includes an NR cell.

In one embodiment, the second failure-related message comprises a type of connection failure.

In one embodiment, the second failure-related message comprises a cause of connection failure.

In one subembodiment, the cause of connection failure comprises foundations of determining a failure of a radio connection with a first serving cell.

In one embodiment, the second failure-related message comprises a cell ID of the first serving cell.

In one embodiment, the second failure-related message comprises a cell ID of the second serving cell.

In one embodiment, the second failure-related message comprises a measResultLastServCell.

In one embodiment, the second failure-related message comprises measResultNeighCells.

In one embodiment, the second failure-related message comprises a measResultListNR.

In one embodiment, the second failure-related message comprises a measResultListEUTRA.

In one embodiment, the second failure-related message comprises a connectionFailureType.

In one embodiment, the second failure-related message comprises a rlf-Cause.

In one embodiment, the second failure-related message comprises a previousPCellId.

In one embodiment, the second failure-related message comprises a failedPCellId.

In one embodiment, the second failure-related message is stored in a variant.

In one embodiment, the second failure-related message is stored in a variant set.

In one embodiment, the second failure-related message is stored in a VarRLF-Report.

In one embodiment, the second failure-related message comprises a message related to the radio connection failure.

In one embodiment, the result of the measurement on the first serving cell comprised in the first failure-related message is the same as the result of the measurement on the first serving cell comprised in the second failure-related message.

In one embodiment, the result of the measurement on the first serving cell comprised in the first failure-related message is different from the result of the measurement on the first serving cell comprised in the second failure-related message.

In one embodiment, the result of the measurement on the neighboring cell of the first serving cell comprised in the first failure-related message is the same as the result of the measurement on the neighboring cell of the first serving cell comprised in the second failure-related message.

In one embodiment, the result of the measurement on the neighboring cell of the first serving cell comprised in the first failure-related message is different from the result of the measurement on the neighboring cell of the first serving cell comprised in the second failure-related message.

In one embodiment, the type of connection failure comprised in the first failure-related message is the same as the type of connection failure comprised in the second failure-related message.

In one embodiment, the type of connection failure comprised in the first failure-related message is different from the type of connection failure comprised in the second failure-related message.

In one embodiment, the cause of connection failure comprised in the first failure-related message is the same as the cause of connection failure comprised in the second failure-related message.

In one embodiment, the cause of connection failure comprised in the first failure-related message is different from the cause of connection failure comprised in the second failure-related message.

In one embodiment, the phrase that the first field of the second failure-related message comprises an identity of the first serving cell includes that the second field of the second failure-related message is used for determining a cell ID of the first serving cell.

In one embodiment, the phrase that the first field of the second failure-related message comprises an identity of the first serving cell includes that the second field of the second failure-related message is used for indicating a cell ID of the first serving cell.

In one embodiment, the phrase that the first field of the second failure-related message comprises an identity of the first serving cell includes that the second field of the second failure-related message is configured as a cell ID of the first serving cell.

In one embodiment, the first field of the second failure-related message comprises a field in a VarRLF-Report.

In one embodiment, the first field of the second failure-related message comprises a field in an RLF-Report.

In one embodiment, the first field of the second failure-related message comprises a field in a UEInformationResponse.

In one embodiment, the first field of the second failure-related message is used for indicating a Source PCell during a last handover.

In one subembodiment, the Source PCell comprises the first serving cell.

In one embodiment, the first field of the second failure-related message comprises a cell ID.

In one embodiment, the first field of the second failure-related message comprises a TAC.

In one embodiment, the first field of the second failure-related message comprises a PLMN.

In one embodiment, the first field of the second failure-related message comprises a previousPCellId.

In one embodiment, the first field of the second failure-related message comprises a failedPCellId.

In one embodiment, the first field of the second failure-related message comprises a cellGlobalId.

In one embodiment, the first field of the second failure-related message comprises a pci-arfcn.

In one embodiment, the first field of the second failure-related message comprises a physCellId.

In one embodiment, the first field of the second failure-related message comprises a carrierFreq.

In one embodiment, the connection failure type field comprises a failureType field.

In one embodiment, the connection failure type field comprises a connectionFailureType field.

In one embodiment, the connection failure type field is used for indicating a type of the connection failure.

In one embodiment, the connection failure type field is used for determining the type of the connection failure.

In one embodiment, the type of the connection failure comprises rlf.

In one embodiment, the type of the connection failure comprises hof.

In one subembodiment, the handover failure includes conventional handover.

In one subembodiment, the handover failure includes CHO failure.

In one subembodiment, the handover failure includes DAPS handover failure.

In one embodiment, the type of the connection failure comprises daps-failure.

In one embodiment, the type of the connection failure comprises rlf-cho-failure.

In one embodiment, the type of the connection failure comprises hof-cho-failure.

In one embodiment, the type of the connection failure comprises source-rlf-daps-failure.

In one embodiment, the first type comprises a value of the connection failure type field.

In one embodiment, the second type comprises a value of the connection failure type field.

In one embodiment, the first type is the same as the second type.

In one embodiment, the first type is different from the second type.

In one embodiment, the first type comprises hof, and the second type comprises hof.

In one embodiment, the first type comprises rlf, and the second type comprises hof.

In one embodiment, the first type comprises rlf, and the second type comprises daps-failure.

In one embodiment, the first type comprises rlf, and the second type comprises cho-failure.

In one embodiment, the first type comprises hof, and the second type comprises cho-failure.

In one embodiment, the name in the present disclosure can be changed to a name corresponding to its function to achieve a same technical effect as the same as the name in the present disclosure.

In one embodiment, letters in the names of signalings, IEs, fields and values, no matter capitalized or in lowercase, can be used to achieve a same technical effect as the same as the name in the present disclosure.

### Embodiment 1B

Embodiment 1B illustrates a flowchart of transmission of a first signaling, a second signaling and a third signaling according to one embodiment of the present disclosure, as shown in FIG. 1B. In FIG. 1B, each box represents a step. It should be noted particularly that the order in which the boxes are arranged does not imply a chronological sequence of each step respectively marked.

In Embodiment 1B, the first node receives a first signaling in step 101B, the first signaling indicating a first candidate cell set; determines a radio connection failure; and as a response to the determined radio connection failure, generates a first variant set and selects a first target cell; configures a first sub-message in the first variant set as an identity of the first target cell in step 102B; in step 103B, when the first target cell belongs to the first candidate cell set, configures a type of the first target cell in the first variant set as a first type, and transmits a second signaling; when the first target cell is not a candidate cell in the first candidate cell set, configures the type of the first target cell in the first variant set as a second type, and transmits a third signaling; herein, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, a transmitter of the first signaling includes a maintenance base station for the first serving cell.

In one subembodiment, the first serving cell comprises a source serving cell.

In one subembodiment, the first serving cell comprises a source cell.

In one subembodiment, the first serving cell comprises a serving cell where a radio connection failure occurs.

In one subembodiment, the first serving cell comprises a PCell of an MCG.

In one subembodiment, the first serving cell comprises a Primary SCG Cell (PSCell) of an SCG.

In one embodiment, the first serving cell and the first target cell belong to a same PLMN.

In one embodiment, a Radio Access Technology (RAT) employed by the PLMN is NR.

In one embodiment, an RAT employed by the PLMN is LTE.

In one embodiment, the first signaling is used to configure for the CHO.

In one embodiment, the first signaling is used to configure for the PSCell Conditional Addition (CPA).

In one embodiment, the first signaling is used to configure for the PSCell Conditional Change (CPC).

In one embodiment, the first signaling is used to configure for MCG failure recovery.

In one embodiment, the first signaling is transmitted via an air interface.

In one embodiment, the first signaling is transmitted via a wireless interface.

In one embodiment, the first signaling is transmitted via a higher layer signaling.

In one embodiment, the first signaling comprises a higher layer signaling.

In one embodiment, the first signaling comprises all or part of a higher layer signaling.

In one embodiment, the first signaling is borne by a Signalling Radio Bearer 1 (SRB1).

In one embodiment, the first signaling is borne by a Split SRB1.

In one embodiment, the first signaling is borne by a Signaling Radio Bearer 3 (SRB3).

In one embodiment, the first signaling comprises a DL signaling.

In one embodiment, a logical channel bearing the first signaling includes a DCCH.

In one embodiment, the first signaling comprises an RRC Message.

In one embodiment, the first signaling comprises all or part of IEs in an RRC Message.

In one embodiment, the first signaling comprises all or part of fields of an IE in an RRC Message.

In one embodiment, the first signaling comprises an RRCReconfiguration message.

In one embodiment, the first signaling comprises an RRCReconfiguration IE.

In one embodiment, the first signaling comprises a ConditionalReconfiguration IE.

In one embodiment, the first signaling comprises a condConfigToAddModList field.

In one embodiment, the first signaling comprises a condConfigToRemoveList field.

In one embodiment, the first signaling comprises an attemptCondReconfig field.

In one embodiment, the first signaling comprises a CondConfigId IE.

In one embodiment, the first signaling comprises a CondConfigToAddModList IE.

In one embodiment, the first signaling comprises a condConfigId field.

In one embodiment, the first signaling comprises a condExecutionCond field.

In one embodiment, the first signaling comprises a condRRCReconfig field.

In one embodiment, the first signaling comprises a RRCConnectionReconfiguration message.

In one embodiment, the first signaling comprises a RRCConnectionReconfigurationIE.

In one embodiment, the first signaling comprises a ConditionalReconfigurationIE.

In one embodiment, the first signaling comprises a CondReconfigurationIdIE.

In one embodiment, the first signaling comprises a condReconfigurationToAddModList field.

In one embodiment, the first signaling comprises a condReconfigurationToRemoveList field.

In one embodiment, the first signaling comprises an attemptCondReconf field.

In one embodiment, the first signaling comprises a CondReconfigurationToRemoveList IE.

In one embodiment, the first signaling comprises a ConditionalReconfigurationIdIE.

In one embodiment, the first signaling comprises a CondReconfigurationToAddModList IE.

In one embodiment, the first signaling comprises a condReconfigurationId field.

In one embodiment, the first signaling comprises a triggerCondition field.

In one embodiment, the first signaling comprises a condReconfigurationToApply field.

In one embodiment, the first signaling comprises a DLInformationTransferMRDC message.

In one embodiment, the first signaling comprises an RRCRelease message.

In one embodiment, the first signaling comprises an RRCConnectionRelease message.

In one embodiment, the first signaling comprises a dl-DCCH-MessageNR IE.

In one embodiment, the first signaling comprises a dl-DCCH-MessageEUTRA IE.

In one embodiment, the phrase that the first signaling indicates a first candidate cell set includes the meaning that the first signaling comprises all or part of the first candidate cell set.

In one embodiment, the phrase that the first signaling indicates a first candidate cell set includes the meaning that the first candidate cell set comprises one or more fields in the first signaling.

In one embodiment, the first candidate cell set comprises at least one inactive serving cell.

In one embodiment, the first candidate cell set comprises the MCG.

In one embodiment, the first candidate cell set comprises multiple serving cells.

In one embodiment, the first candidate cell set comprises K first-type candidate cell(s), K being a positive integer.

In one embodiment, the first candidate cell set comprises a CHO candidate cell set.

In one embodiment, the radio connection failure comprises an MCG failure.

In one embodiment, the radio connection failure comprises an SCG failure.

In one embodiment, the radio connection failure comprises a failure in re-configuration with sync of a PCell group.

In one embodiment, the radio connection failure comprises an RRC Connection Reestablishment failure.

In one embodiment, the radio connection failure comprises an RLF.

In one embodiment, the radio connection failure comprises a Handover Failure (HOF).

In one subembodiment, the HOF includes the CHO failure.

In one subembodiment, the HOF includes a conventional handover failure.

In one subembodiment, the HOF includes a DAPS handover failure.

In one embodiment, the phrase of determining a radio connection failure includes that the first node determines that a radio connection with the first serving cell is failed.

In one embodiment, the first node determines a radio connection failure based on a radio measurement.

In one subembodiment, the radio measurement is for the first serving cell.

In one subembodiment, the radio measurement comprises measuring a Synchronization Signal (SS).

In one subembodiment, the radio measurement comprises a Cell-specific Reference Signal (CRS).

In one subembodiment, the radio measurement comprises a Synchronization Signal Reference Signal (SS-RS).

In one subembodiment, the radio measurement comprises a Synchronization Signal Block (SSB).

In one subembodiment, the radio measurement comprises a Primary Synchronization Signal.

In one subembodiment, the radio measurement comprises a Secondary Synchronization Signal (SSS).

In one subembodiment, the radio measurement comprises an SS/PBCH block.

In one subembodiment, the radio measurement comprises measuring a Channel State Information Reference Signal (CSI-RS).

In one subembodiment, the radio measurement comprises measuring a cell-common Physical Downlink Control Channel (PDCCH).

In one subembodiment, the radio measurement comprises measuring a Physical Broadcast Channel (PBCH).

In one embodiment, when the timer T310 is expired, the first node determines a radio connection failure; herein, the T310 is for a first serving cell.

In one embodiment, when the timer T312 is expired, the first node determines a radio connection failure; herein, the T312 is for a first serving cell.

In one embodiment, when an indication of reaching a maximum number of retransmissions is received from MCG RLC, the first node determines a radio connection failure.

In one embodiment, when an indication of reaching a maximum number of retransmissions of an SRB or a DRB is received from MCG RLC, the first node determines a radio connection failure.

In one embodiment, when receiving an indication of an issue of random access from MCG MAC, and none of the timers T300, T301, T304, T311 and T319 is running, the first node determines that the radio link with the first serving cell is failed.

In one embodiment, when receiving an indication of an issue of random access from MCG MAC, and none of the timers T300, T301, T304 and T311 is running, the first node determines that the radio link with the first serving cell is failed.

In one embodiment, the first node determines that a radio connection with a first serving cell is failed, the first serving cell belonging to an MCG.

In one embodiment, the phrase that the first variant set is related to an RLF-related message includes the meaning that the first variant set comprises the RLF-related message.

In one embodiment, the phrase that the first variant set is related to an RLF-related message includes the meaning that the first variant set is used for storing the RLF-related message.

In one subembodiment, the RLF-related message comprises information of the RLF.

In one subembodiment, the RLF-related message comprises information of the HOF.

In one embodiment, the phrase of “as a response to the determined radio connection failure, generating a first variant set and selecting a first target cell” includes the meaning that the action of generating a first variant set and selecting a first target cell is triggered by the radio connection failure.

In one embodiment, the phrase of “as a response to the determined radio connection failure, generating a first variant set and selecting a first target cell” includes the meaning that when the radio connection failure occurs, the first node generates a first variant set and selects a first target cell.

In one embodiment, the phrase of “as a response to the determined radio connection failure” includes the meaning of as a next step following the determined radio connection failure.

In one embodiment, the phrase of “as a response to the determined radio connection failure” includes the meaning of as a next step following the first node declaring the determined radio connection failure.

In one embodiment, the phrase of “as a response to the determined radio connection failure” includes the meaning of a procedure performed after an MCG is seen as having undergone the radio connection failure.

In one embodiment, the phrase of generating a first variant set includes the meaning of storing the RLF-related message in the first variant set.

In one embodiment, the phrase of generating a first variant set includes the meaning of configuring one or more fields in the first variant set as a content related to the radio link failure.

In one embodiment, the phrase of generating a first variant set includes the meaning that if the first variant set stores content, it shall first clear the content of the first variant set and then store the RLF-related message.

In one embodiment, the phrase of generating a first variant set includes storing the first variant set.

In one embodiment, the phrase of generating a first variant set includes saving the first variant set.

In one embodiment, the phrase of generating a first variant set includes setting the first variant set.

In one embodiment, the phrase of generating a first variant set includes logging the first variant set.

In one embodiment, the first variant set is used for storing the RLF-related message.

In one embodiment, the first variant set is based on UE implementation.

In one embodiment, the first variant set comprises a VarRLF-Report.

In one embodiment, the first variant set comprises a rlf-Report.

In one embodiment, the first variant set comprises a message stored in a VarRLF-Report.

In one embodiment, the first variant set comprises all fields in a VarRLF-Report.

In one embodiment, the first variant set comprises part of fields in a VarRLF-Report.

In one embodiment, the first variant set comprises a plmn-IdentityList field.

In one embodiment, the first variant set comprises a plmn-Identity field.

In one embodiment, a value of the first variant set comprises an RLF-Report.

In one embodiment, a value of the first variant set comprises a first sub-message.

In one embodiment, the phrase of selecting the first target cell includes the meaning that a cell selected by the first node through Cell Selection is the first target cell.

In one embodiment, the phrase of selecting the first target cell includes the meaning that the first node determines the first target cell.

In one embodiment, the first target cell comprises a cell selected according to a measurement result.

In one embodiment, the first target cell comprises a neighboring cell of a source serving cell.

In one embodiment, the first target cell comprises a source serving cell.

In one embodiment, the first target cell comprises a CHO candidate cell.

In one embodiment, the first target cell comprises a PCell.

In one embodiment, the first target cell belongs to a first candidate cell set.

In one embodiment, the first target cell does not belong to a first candidate cell set.

In one embodiment, the phrase of configuring a first sub-message in a first variant set as an identity of the first target cell includes the meaning that the first variant set comprises the first sub-message, and the first sub-message is used for determining the identity of the first target cell.

In one subembodiment, the determining refers to indicating.

In one subembodiment, the determining refers to comprising.

In one embodiment, the first sub-message comprises one or more fields in the first variant set.

In one embodiment, the first sub-message comprises the identity of the first target cell.

In one embodiment, the first sub-message is related to the identity of the first target cell.

In one embodiment, the identity of the first target cell includes a CellGlobalIdentity (CGI) of the first target cell.

In one embodiment, the identity of the first target cell includes an Evolved Cell Global Identifier (ECGI) of the first target cell.

In one embodiment, the identity of the first target cell includes a PhysicalCellIdentity (PCI) of the first target cell.

In one embodiment, the phrase that the first target cell belongs to the first candidate cell set includes the meaning that the first target cell is a candidate cell in the first candidate cell set.

In one embodiment, the phrase that the first target cell belongs to the first candidate cell set includes the meaning that the first node selects a proper cell and the selected cell is a CHO candidate cell.

In one embodiment, the phrase of configuring a type of the first target cell in the first variant set as a first type includes the meaning that the first sub-message in the first variant set is associated with the first type of the first target cell.

In one embodiment, the phrase of configuring a type of the first target cell in the first variant set as a first type includes the meaning that the type of the first target cell is indicated as a first type.

In one embodiment, when the first target cell belongs to the first candidate cell set, the type of the first target cell includes the first type.

In one embodiment, the first type is used for determining that a reconfiguration procedure of the radio resource control is performed after the first target cell is selected.

In one embodiment, the first type is used for determining that a recovery procedure of the radio connection failure is performed after the first target cell is selected.

In one embodiment, the first type is used for determining that a CHO procedure is performed after the first target cell is selected.

In one embodiment, the first type is used for determining that a conditional configuration procedure is performed after the first target cell is selected.

In one subembodiment, the conditional configuration comprises a CHO of a PCell.

In one subembodiment, the conditional configuration comprises a CPC of a PSCell.

In one embodiment, the phrase that the second signaling is used to determine that reconfiguration of a radio resource control connection is successful means that the second signaling is used for acknowledging for an RRCConnectionReconfiguration message.

In one embodiment, the phrase that the second signaling is used to determine that reconfiguration of a radio resource control connection is successful means that the second signaling is used for acknowledging for an RRCReconfiguration message.

In one embodiment, the phrase that the second signaling is used to determine that reconfiguration of a radio resource control connection is successful means that the second signaling is used for acknowledging for the first signaling.

In one embodiment, a receiver of the second signaling includes a maintenance base station for the first target cell.

In one embodiment, a receiver of the second signaling includes a PCell in which a radio link failure occurs.

In one embodiment, the second signaling is transmitted via an air interface.

In one embodiment, the second signaling is transmitted via a wireless interface.

In one embodiment, the second signaling is transmitted via a higher layer signaling.

In one embodiment, the second signaling comprises a higher layer signaling.

In one embodiment, the second signaling comprises all or part of a higher layer signaling.

In one embodiment, the second signaling comprises an RRC message.

In one embodiment, the second signaling comprises all or part of IEs in an RRC message.

In one embodiment, the second signaling comprises all or part of fields of an IE in an RRC message.

In one embodiment, the second signaling is used for an RRC Connection Reconfiguration procedure.

In one embodiment, the second signaling is used for a recovery procedure of the radio connection failure.

In one embodiment, a Signaling Radio Bearer of the second signaling includes SRB1.

In one embodiment, a Signaling Radio Bearer of the second signaling includes SRB3.

In one embodiment, the second signaling comprises an Uplink (UL) signaling.

In one embodiment, a logical channel bearing the second signaling includes a DCCH.

In one embodiment, the second signaling comprises an RRCConnectionReconfigurationComplete message.

In one embodiment, the second signaling comprises an RRCReconfigurationComplete message.

In one embodiment, the phrase that the second signaling comprises a first message means that the first message is a field or an IE in the second signaling.

In one embodiment, the phrase that the second signaling comprises a first message means that with the content in the second signaling being configured, if the first node stores the RLF-related message in the first variant set, the second signaling comprises the first message.

In one embodiment, the phrase that the first target cell is not a candidate cell in the first candidate cell set means that the first target cell is not a CHO candidate cell.

In one embodiment, the phrase that the first target cell is not a candidate cell in the first candidate cell set means that the first target cell does not belong to the first candidate cell set.

In one embodiment, the phrase that the first target cell is not a candidate cell in the first candidate cell set means that the first node selects a proper cell, and the selected cell is not a CHO candidate cell.

In one embodiment, the phrase of configuring a type of the first target cell in the first variant set as a second type means that the first sub-message in the first variant set is associated with the second type of the first target cell.

In one embodiment, when the first target cell does not belong to the first candidate cell set, a type of the first target cell is the second type.

In one embodiment, the second type is used for determining that a procedure of the radio resource control reestablishment is performed after the first target cell is selected.

In one embodiment, the second type is used for determining that the first target cell does not belong to the first candidate cell set.

In one embodiment, the phrase that the third signaling is used to request reestablishment of the radio resource control connection means that the third signaling is used for initiating the procedure of reestablishment of the radio resource control connection.

In one embodiment, the phrase that the third signaling is used to request reestablishment of the radio resource control connection means that the third signaling comprises a first message of the procedure of reestablishment of the radio resource control connection.

In one embodiment, the third signaling is transmitted via an air interface.

In one embodiment, the third signaling is transmitted via a wireless interface.

In one embodiment, the third signaling is transmitted via a higher layer signaling.

In one embodiment, the third signaling comprises a higher layer signaling.

In one embodiment, the third signaling comprises all or part of a higher layer signaling.

In one embodiment, the third signaling comprises an RRC message.

In one embodiment, the third signaling comprises all or part of IEs in an RRC message.

In one embodiment, the third signaling comprises all or part of fields of an IE in an RRC message.

In one embodiment, a Signaling Radio Bearer of the third signaling includes SRB0.

In one embodiment, a logical channel bearing the third signaling includes a Common Control Channel (CCCH).

In one embodiment, the third signaling comprises an RRCReestablishmentRequest message.

In one embodiment, the third signaling comprises an RRCConnectionReestablishmentRequest message.

In one embodiment, the phrase that the third signaling does not comprise the first message means that the first message is not a field or an IE in the third signaling.

In one embodiment, the phrase that the third signaling does not comprise the first message means that when contents in the third signaling are configured, the second signaling does not comprise the first message.

In one embodiment, the first message is used for determining whether there is RLF information in a VarRLF-Report.

In one embodiment, the first message is used for determining whether there is HOF information in a VarRLF-Report.

In one embodiment, the first message comprises all or part of a higher layer signaling.

In one embodiment, the first message comprises all or part of an RRC signaling.

In one embodiment, the first message indicates whether the RLF-related message is currently stored in the first variant set.

In one embodiment, the first message indicates whether there is the RLF-related message not yet reported in the first variant set.

In one embodiment, the first message is used by a receiver for scheduling the first node in reporting a UEInformationResponse.

In one embodiment, the first message comprises rlf-InfoAvailable.

In one embodiment, the phrase that the first message is used to determine whether there is the RLF-related message means that the first message is used for explicitly indicating whether the RLF-related message exists.

In one subembodiment, the first message comprises a Boolean value, the Boolean value comprising a true value and a false value.

In one subsidiary embodiment of the above subembodiment, when the first message comprises a true value, the first message indicates that there is the RLF-related message.

In one subsidiary embodiment of the above subembodiment, when the first message comprises a false value, the first message indicates that there isn't the RLF-related message.

In one subsidiary embodiment of the above subembodiment, the true value comprises 1 and the false value comprises 0.

In one embodiment, the phrase that the first message is used to determine whether there is the RLF-related message means that the first message is used for implicitly indicating whether there is the RLF-related message.

In one subembodiment, when the first message exists, the first message indicates that there is the RLF-related message.

In one subsidiary embodiment of the above subembodiment, the phrase that the first message exists means that the first message is configured as true.

In one embodiment, the type of the first target cell comprises functions of the first target cell.

In one embodiment, the type of the first target cell is used for determining procedures subsequently performed by the first node.

In one embodiment, the type of the first target cell comprises that the first target cell is a cell used for performing reestablishment of radio resource control connection.

In one embodiment, the type of the first target cell comprises that the first target cell is a cell used for performing reconfiguration of radio resource control connection.

In one embodiment, the type of the first target cell comprises that the first target cell is a cell used for performing recovery of radio connection failure.

In one subembodiment, the recovery of the radio connection failure comprises recovering through CHO after the radio connection failure.

In one subembodiment, the recovery of the radio connection failure comprises recovering through Fast MCG Recovery performed by an SCG after the radio connection failure.

In one embodiment, when a type of the first target cell in the first variant set is configured as a second type, the first variant set comprises the first sub-message.

In one embodiment, the first type is the same as the second type.

In one embodiment, the first type is different from the second type.

In one embodiment, the first type and the second type are used for determining that the first target cell is used for performing different procedures.

### Embodiment 2

Embodiment 2 illustrates a schematic diagram of a network architecture according to the present disclosure, as shown in FIG. 2. FIG. 2 is a diagram illustrating a network architecture 200 of 5G NR, Long-Term Evolution (LTE), and Long-Term Evolution Advanced (LTE-A) systems. The 5G NR or LTE network architecture 200 may be called an 5G System/Evolved Packet System (5GS/EPS) 200 or any other appropriate term. The 5GS/EPS 200 may comprise one or more UEs 201, an NG-RAN 202, an 5G-Core Network/Evolved Packet Core (5G-CN/EPC) 210, a Home Subscriber Server (HSS) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present disclosure can be extended to networks providing circuit switching services. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Non-terrestrial base station communications, Stellate mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/UPF 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW/UPF 213 provides UE IP address allocation and other functions. The P-GW/UPF 213 is connected to the Internet Service 230. The Internet Service 230 comprises operator-compatible IP services, specifically including Internet, Intranet, IP Multimedia Subsystem (IMS) and Packet Switching Streaming (PSS) services.

In one embodiment, the UE 201 corresponds to the first node in the present disclosure.

In one embodiment, the UE 201 supports transmissions in Non-terrestrial Networks (NTN).

In one embodiment, the UE 201 supports transmissions in networks with large delay difference.

In one embodiment, the UE 201 supports transmissions in Terrestrial Networks (TN).

In one embodiment, the UE 201 supports Dual Connectivity (DC) transmissions.

In one embodiment, the UE 201 supports Dual Active Protocol Stack (DAPS) transmissions.

In one embodiment, the UE 201 is a UE.

In one embodiment, the UE 201 is an ender.

In one embodiment, the gNB 203 corresponds to the second node in the present disclosure.

In one embodiment, the gNB 203 corresponds to the third node in the present disclosure.

In one embodiment, the gNB 203 corresponds to the fourth node in the present disclosure.

In one embodiment, the gNB 203 supports transmissions in NTN.

In one embodiment, the gNB 203 supports transmissions in networks with large delay difference.

In one embodiment, the gNB 203 supports transmissions in TN.

In one embodiment, the gNB 203 supports DC transmissions.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

### Embodiment 3

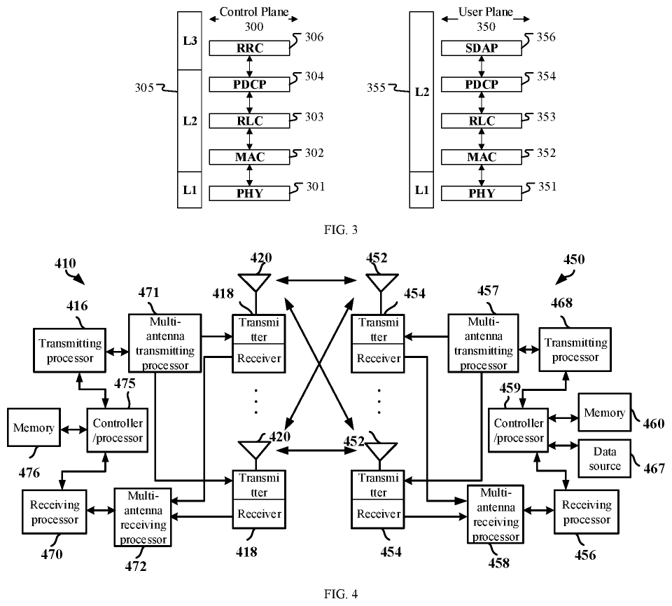

Embodiment 3 illustrates a schematic diagram of a radio protocol architecture of a user plane and a control plane according to the present disclosure, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are a layer 1, a layer 2 and a layer 3, respectively. The layer 1 (L1) is the lowest layer which performs signal processing functions of various PHY layers. The L1 is called PHY 301 in the present disclosure. The layer 2 (L2) 305 is above the PHY 301, comprising a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the radio protocol architecture in FIG. 3 is applicable to the third node in the present disclosure.

In one embodiment, the radio protocol architecture in FIG. 3 is applicable to the fourth node in the present disclosure.

In one embodiment, the first signaling in the present disclosure is generated by the RRC 306.

In one embodiment, the second signaling in the present disclosure is generated by the RRC 306.

In one embodiment, the third signaling in the present disclosure is generated by the RRC 306.

In one embodiment, the fourth signaling in the present disclosure is generated by the RRC 306.

In one embodiment, the fifth signaling in the present disclosure is generated by the RRC 306.

In one embodiment, the second message in the present disclosure is generated by the RRC 306.

In one embodiment, the third information set in the present disclosure is generated by the RRC 306.

### Embodiment 4

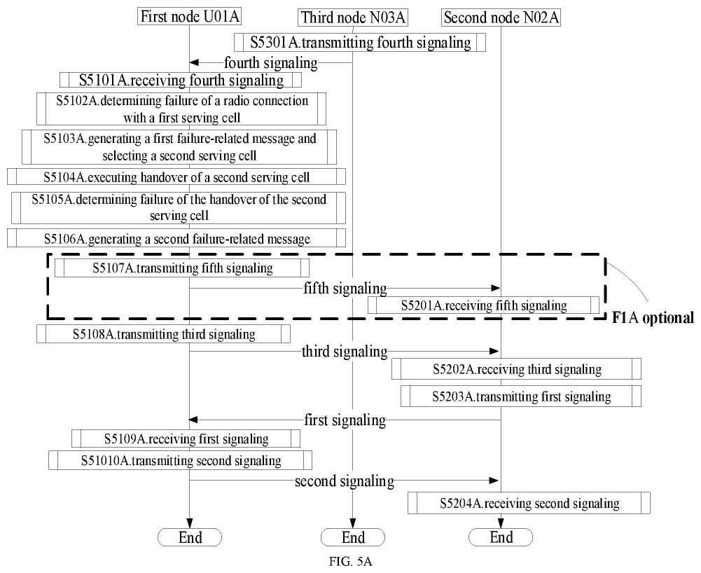

Embodiment 4 illustrates a schematic diagram of a first communication device and a second communication device according to the present disclosure, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 implements the functionality of the L2 layer. In the transmission from the second communication device 410 to the first communication device 450, the controller/processor 475 provides header compression, encryption, packet segmentation and reordering, multiplexing between a logical channel and a transport channel and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, including codebook-based precoding and non-codebook-based precoding, and beamforming processing on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to antennas 420.

In a transmission from the second communication device 410 to the first communication device 450, at the first communication device 450, each receiver 454 receives a signal via a corresponding antenna 452. Each receiver 454 recovers information modulated onto the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410. Next, the higher-layer data and control signal are provided to the controller/processor 459. The controller/processor 459 performs functions of the L2 layer. The controller/processor 459 can be associated with a memory 460 that stores program code and data. The memory 460 can be called a computer readable medium. In the transmission from the second communication device 410 to the first communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least determines a failure of a radio connection with a first serving cell; and generates a first failure-related message and selects a second serving cell as a response to the determined failure of the radio connection with the first serving cell; and executes a handover of the second serving cell; determines a failure of the handover of the second serving cell; and generates a second failure-related message as a response to the failure of the handover of the second serving cell; receives a first signaling; and transmits a second signaling; herein, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the first communication device 450 comprises a memory that stores a computer readable instruction program. The computer readable instruction program generates actions when executed by at least one processor. The actions include: determining a failure of a radio connection with a first serving cell; and generating a first failure-related message and selecting a second serving cell as a response to the determined failure of the radio connection with the first serving cell; and executing a handover of the second serving cell; determining a failure of the handover of the second serving cell; and generating a second failure-related message as a response to the failure of the handover of the second serving cell; receiving a first signaling; and transmitting a second signaling; herein, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the second communication device 410 comprises at least one processor and at least one memory. The at least one memory comprises computer program codes. The at least one memory and the computer program codes are configured to be used in collaboration with the at least one processor. The second communication device 410 at least transmits a first signaling; and receives a second signaling; herein, as a response to determining a failure of the radio connection with the first serving cell, a first failure-related message is generated and the second serving cell is selected; as a response to determining a failure of a handover of the second serving cell, a second failure-related message is generated; the first signaling is transmitted after the second failure-related message is generated, the first signaling is used for triggering the second signaling, the second signaling comprising the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the second communication device 410 comprises a memory that stores a computer readable instruction program. The computer readable instruction program generates actions when executed by at least one processor. The actions include: transmitting a first signaling; and receiving a second signaling; herein, as a response to determining a failure of the radio connection with the first serving cell, a first failure-related message is generated and the second serving cell is selected; as a response to determining a failure of a handover of the second serving cell, a second failure-related message is generated; the first signaling is transmitted after the second failure-related message is generated, the first signaling is used for triggering the second signaling, the second signaling comprising the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first signaling, the first signaling indicating a first candidate cell set; determines a radio connection failure; and as a response to the determined radio connection failure, generates a first variant set and selects a first target cell; configures a first sub-message in the first variant set as an identity of the first target cell; when the first target cell belongs to the first candidate cell set, configures a type of the first target cell in the first variant set as a first type, and transmits a second signaling; when the first target cell is not a candidate cell in the first candidate cell set, configures the type of the first target cell in the first variant set as a second type, and transmits a third signaling; herein, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, the first communication device 450 comprises a memory that stores a computer readable instruction program. The computer readable instruction program generates actions when executed by at least one processor. The actions include: receiving a first signaling, the first signaling indicating a first candidate cell set; determining a radio connection failure; and as a response to the determined radio connection failure, generating a first variant set and selecting a first target cell; configuring a first sub-message in the first variant set as an identity of the first target cell; when the first target cell belongs to the first candidate cell set, configuring a type of the first target cell in the first variant set as a first type, and transmitting a second signaling; when the first target cell is not a candidate cell in the first candidate cell set, configuring the type of the first target cell in the first variant set as a second type, and transmitting a third signaling; herein, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, the second communication device 410 comprises at least one processor and at least one memory. The at least one memory comprises computer program codes. The at least one memory and the computer program codes are configured to be used in collaboration with the at least one processor. The second communication device 410 at least configures a first sub-message in a first variant set as an identity of a first target cell; when the first target cell belongs to a first candidate cell set, configures a type of the first target cell in the first variant set as a first type, and receives a second signaling; when the first target cell is not a candidate cell in the first candidate cell set, configures a type of the first target cell in the first variant set as a second type, and receives a third signaling; herein, the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, the second communication device 410 comprises a memory that stores a computer readable instruction program. The computer readable instruction program generates actions when executed by at least one processor. The actions include: configuring a first sub-message in a first variant set as an identity of a first target cell; when the first target cell belongs to a first candidate cell set, configuring a type of the first target cell in the first variant set as a first type, and receiving a second signaling; when the first target cell is not a candidate cell in the first candidate cell set, configuring a type of the first target cell in the first variant set as a second type, and receiving a third signaling; herein, the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, the antenna 452, the receiver 454, the receiving processor 456, the controller/processor 459 are used for receiving a first signaling; at least one of the antenna 420, the transmitter 418, the transmitting processor 416, or the controller/processor 475 is used for transmitting the first signaling.

In one embodiment, the antenna 452, the transmitter 454, the transmitting processor 468 and the controller/processor 459 are used for transmitting a second signaling; at least one of the antenna 420, the receiver 418, the receiving processor 470 or the controller/processor 475 is used for receiving the second signaling.

In one embodiment, the antenna 452, the transmitter 454, the transmitting processor 468 and the controller/processor 459 are used for transmitting a third signaling; at least one of the antenna 420, the receiver 418, the receiving processor 470 or the controller/processor 475 is used for receiving the third signaling.

In one embodiment, the antenna 452, the receiver 454, the receiving processor 456, the controller/processor 459 are used for receiving a fourth signaling; at least one of the antenna 420, the transmitter 418, the transmitting processor 416, or the controller/processor 475 is used for transmitting the fourth signaling.

In one embodiment, the antenna 452, the transmitter 454, the transmitting processor 468 and the controller/processor 459 are used for transmitting a fifth signaling; at least one of the antenna 420, the receiver 418, the receiving processor 470 or the controller/processor 475 is used for receiving the fifth signaling.

In one embodiment, the antenna 452, the receiver 454, the receiving processor 456, the controller/processor 459 are used for receiving a first signaling; at least one of the antenna 420, the transmitter 418, the transmitting processor 416, or the controller/processor 475 is used for transmitting the first signaling.

In one embodiment, the antenna 452, the transmitter 454, the transmitting processor 468 and the controller/processor 459 are used for transmitting a second signaling; at least one of the antenna 420, the receiver 418, the receiving processor 470 or the controller/processor 475 is used for receiving the second signaling.

In one embodiment, the antenna 452, the receiver 454, the receiving processor 456, the controller/processor 459 are used for receiving a fourth signaling; at least one of the antenna 420, the transmitter 418, the transmitting processor 416, or the controller/processor 475 is used for transmitting the fourth signaling.

In one embodiment, the antenna 452, the transmitter 454, the transmitting processor 468 and the controller/processor 459 are used for transmitting a third signaling and a fifth signaling; at least one of the antenna 420, the receiver 418, the receiving processor 470 or the controller/processor 475 is used for receiving the third signaling and the fifth signaling.

In one embodiment, the antenna 452, the receiver 454, the receiving processor 456, the controller/processor 459 are used for receiving a second message; at least one of the antenna 420, the transmitter 418, the transmitting processor 416, or the controller/processor 475 is used for transmitting the second message.

In one embodiment, the antenna 452, the transmitter 454, the transmitting processor 468 and the controller/processor 459 are used for transmitting a third information set; at least one of the antenna 420, the receiver 418, the receiving processor 470 or the controller/processor 475 is used for receiving the third information set.

In one embodiment, the first communication device 450 corresponds to the first node in the present disclosure.

In one embodiment, the first communication device 450 is a UE.

In one embodiment, the first communication device 450 is an Ender.

In one embodiment, the first communication device 450 is a UE supporting DAPS.

In one embodiment, the first communication device 450 is a UE supporting Dual Connectivity.

In one embodiment, the first communication device 450 is a UE supporting large delay difference.

In one embodiment, the first communication device 450 is a UE supporting NTN.

In one embodiment, the first communication device 450 is a UE supporting TN.

In one embodiment, the second communication device 410 corresponds to the second node in the present disclosure.

In one embodiment, the second communication device 410 corresponds to the third node in the present disclosure.

In one embodiment, the second communication device 410 corresponds to the fourth node in the present disclosure.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is a base station supporting TN.

### Embodiment 5A

Embodiment 5A illustrates a flowchart of radio signal transmission according to one embodiment of the present disclosure, as shown in FIG. 5A. A first node U01A comprises a UE; a second node N02A comprises a maintenance base station for a second serving cell; and a third node N03A comprises a maintenance base station for a first serving cell; it should be noted particularly that the order illustrated herein does not imply sequence orders of signal transmissions and implementations in the present disclosure.

The first node U01A receives a fourth signaling in step S5101A and determines a failure of a radio connection with a first serving cell in step S5102A, generates a first failure-related message and selects a second serving cell in step S5103A, executes a handover of a second serving cell in step S5104A, determines a failure of the handover of the second serving cell in step S5105A, and generates a second failure-related message in step S5106A, transmits a fifth signaling in step S5107A, transmits a third signaling in step S5108A, receives a first signaling in step S5109A and transmits a second signaling in step S51010A.

The second node N02A receives a fifth signaling in step S5201A, receives a third signaling in step S5202A, transmits a first signaling in step S5203A and receives a second signaling in step S5204A.

The third node N03A transmits a fourth signaling in step S5301A.

In Embodiment 5A, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type; the second signaling comprises the first failure-related message; the third signaling comprises a first message, the first message being used for indicating that the first failure-related message and the second failure-related message are generated; the first signaling indicates a message to be reported, and the second signaling comprises the message to be reported, the message to be reported comprising at least one of the first failure-related message or the second failure-related message; the fourth signaling comprises configuration information of the second serving cell; a first target cell is selected as a response to the determined failure of the handover of the second serving cell, a third field of the second failure-related message is configured as an identity of the first target cell; and the fifth signaling is used for requesting a connection reestablishment, and the first target cell is used for the connection reestablishment; clearing the first failure-related message, and the second failure-related message comprises the first failure-related message.

In one embodiment, the first node U01A supports DAPS.

In one embodiment, the second node N02A comprises a CHO candidate cell.

In one embodiment, the second node N02A comprises a Target Cell.

In one embodiment, the second node N02A comprises a target cell in which the HOF occurs.

In one embodiment, the third node N03A comprises a Source Cell.

In one embodiment, the third node N03A comprises a PCell in which the radio connection failure occurs.

In one embodiment, the third node N03A comprises a Source PCell in which the radio connection failure occurs.

In one embodiment, the third node N03A comprises a Source PCell in which the HOF occurs.

In one embodiment, the second signaling comprises the first failure-related message, but not the second failure-related message.

In one embodiment, the second signaling comprises the second failure-related message and the first failure-related message.

In one embodiment, the phrase that the second signaling comprises the first failure-related message means that the first failure-related message is one or more fields of the second signaling.

In one embodiment, the phrase that the second signaling comprises the first failure-related message means that the first failure-related message is one or more IEs of the second signaling.

In one embodiment, the phrase that the second signaling comprises the first failure-related message means that the second signaling is used for bearing the first failure-related message.

In one embodiment, the phrase that the second signaling comprises the first failure-related message means that the second signaling is used for determining the first failure-related message.

In one embodiment, the second signaling comprises all of the first failure-related message.

In one embodiment, the second signaling comprises part of the first failure-related message.

In one embodiment, the third signaling is transmitted via an air interface.

In one embodiment, the third signaling is transmitted via a wireless interface.

In one embodiment, the third signaling is transmitted via a higher layer signaling.

In one embodiment, the third signaling comprises a higher layer signaling.

In one embodiment, the third signaling comprises all or part of a higher layer signaling.

In one embodiment, the third signaling comprises an RRC message.

In one embodiment, the third signaling comprises all or part of IEs in an RRC message.

In one embodiment, the third signaling comprises all or part of fields of an IE in an RRC message.

In one embodiment, the third signaling is used for an RRC Connection Reconfiguration procedure.

In one embodiment, the third signaling is used for a recovery procedure of the radio connection failure.

In one embodiment, a Signaling Radio Bearer of the third signaling includes SRB1.

In one embodiment, a Signaling Radio Bearer of the third signaling includes SRB3.

In one embodiment, the third signaling comprises an uplink signaling.

In one embodiment, a logical channel of the third signaling includes a DCCH.

In one embodiment, the third signaling comprises an RRCConnectionReconfigurationComplete message.

In one embodiment, the third signaling comprises an RRCReconfigurationComplete message.

In one embodiment, the third signaling comprises an RRCReestablishmentComplete message.

In one embodiment, the third signaling comprises an RRCConnectionReestablishmentComplete message.

In one embodiment, the third signaling comprises an RRCConnectionSetupComplete message.

In one embodiment, the third signaling comprises an RRCSetupComplete message.

In one embodiment, the third signaling comprises an RRCConnectionResumeComplete message.

In one embodiment, the third signaling comprises an RRCResumeComplete message.

In one embodiment, the first message comprises a rlf-InfoAvailable field.

In one embodiment, the first message is used for replacing a rlf-InfoAvailable field.

In one embodiment, the first message is used for indicating whether there is the first failure-related message or the second failure-related message in the first node U01A.

In one embodiment, the first message comprises one bit.

In one subembodiment, the third signaling comprises that the first message is used for indicating that there is the first failure-related message or the second failure-related message in the first node U01A.

In one subsidiary embodiment of the above subembodiment, the first message being configured as is used to indicate that there is the first failure-related message in the first node U01A.

In one subsidiary embodiment of the above subembodiment, the first message being configured as is used to indicate that there is the second failure-related message in the first node U01A.

In one subembodiment, the third signaling does not comprise that the first message is used for indicating that there isn't the first failure-related message or the second failure-related message in the first node U01A.

In one embodiment, the first message comprises Q1 bits, Q1 being a positive integer greater than 1.

In one embodiment, the first message comprises 2 bits.

In one subembodiment, the first message indicates a first status out of Q2 statuses, Q2 being a positive integer greater than 2.

In one subsidiary embodiment of the above subembodiment, the first status indicates that both of the first failure-related message and the second failure-related message are generated.

In one subsidiary embodiment of the above subembodiment, the first status indicates that neither of the first failure-related message and the second failure-related message are generated.

In one subsidiary embodiment of the above subembodiment, the first status indicates that either of the first failure-related message and the second failure-related message is generated.

In one subembodiment, Q2 is equal to 3.

In one embodiment, of the Q2 statuses there is one status being reserved (i.e., undefined).

In one subembodiment, Q2 is equal to 4.

In one embodiment, the phrase that the first signaling indicates a message to be reported includes that the first signaling is used for requesting the message to be reported.

In one embodiment, the phrase that the first signaling indicates a message to be reported includes that the first signaling comprises requesting a field of the message to be reported.

In one embodiment, the message to be reported comprises an RLF-related message in storage.

In one embodiment, the message to be reported comprises a random-access-related message in storage.

In one embodiment, the message to be reported comprises a mobility-related message in storage.

In one embodiment, the message to be reported comprises an RLF-recovery-related message in storage.

In one embodiment, the first signaling comprises a UEInformationRequest message.

In one embodiment, a first indication symbol is used for indicating the message to be reported.

In one embodiment, the first indication symbol comprises a field of the first signaling.

In one embodiment, the first indication symbol is used for indicating a number of messages to be reported.

In one embodiment, the first indication symbol is used for indicating an identity of the message to be reported.

In one embodiment, the first indication symbol is used for indicating the report of all the message to be reported stored in the first node U01A.

In one embodiment, the first indication symbol is used for indicating the report of part of the message to be reported stored in the first node U01A.

In one embodiment, the first indication symbol is used for indicating the report of a last one of the messages to be reported stored in the first node U01A.

In one embodiment, the first indication symbol is used for indicating that the message to be reported comprises the first failure-related message.

In one embodiment, the first indication symbol is used for indicating that the message to be reported comprises the second failure-related message.

In one embodiment, the first indication symbol is used for indicating that the message to be reported comprises the first failure-related message and the second failure-related message.

In one embodiment, the first indication symbol comprises a ra-ReportReq.

In one embodiment, the first indication symbol comprises a connEstFailReportReq.

In one embodiment, the first indication symbol comprises a rlf-ReportReq.

In one embodiment, the first indication symbol comprises a mobilityHistoryReportReq.

In one embodiment, the first indication symbol comprises a nonCriticalExtension.

In one embodiment, the first indication symbol comprises a rlfRecoveryReportReq.

In one embodiment, the first signaling comprises a first indication symbol, and a value of the first indication symbol is set as true, so as to indicate the need for reporting the message to be reported.

In one embodiment, the first signaling does not comprise that the first indication symbol is used for indicating that there is no need for reporting the message to be reported.

In one embodiment, the first indication symbol comprises K2 bits, K2 being a positive integer greater than 1.

In one subembodiment, when the first indication symbol comprises 00, there is no need for reporting the message to be reported.

In one subembodiment, when the first indication symbol comprises 01, the message to be reported comprises the first failure-related message.

In one subembodiment, when the first indication symbol comprises 10, the message to be reported comprises the second failure-related message.

In one subembodiment, when the first indication symbol comprises 11, the message to be reported comprises the first failure-related message and the second failure-related message.

In one embodiment, the phrase that the second signaling comprises the message to be reported means: the second signaling is used for carrying the message to be reported.

In one embodiment, the phrase that the second signaling comprises the message to be reported means: the message to be reported is reported through the second signaling.

In one embodiment, the phrase that the second signaling comprises the message to be reported means: the second signaling is a response of the first signaling.

In one embodiment, the phrase that the second signaling comprises the message to be reported means: the first node U01A reports through the second signaling according to the message to be reported that is indicated in the first signaling.

In one embodiment, the second signaling comprises a RA-Report.

In one embodiment, the second signaling comprises a ConnEstFailReport.

In one embodiment, the second signaling comprises an RLF-Report.

In one embodiment, the second signaling comprises a MobilityHistoryReport.

In one embodiment, the second signaling comprises a RlfRecoveryReportReq.

In one embodiment, the phrase that the message to be reported comprises at least one of the first failure-related message or the second failure-related message means that the message to be reported comprises the first failure-related message.

In one embodiment, the phrase that the message to be reported comprises at least one of the first failure-related message or the second failure-related message means that the message to be reported comprises the second failure-related message.

In one embodiment, the phrase that the message to be reported comprises at least one of the first failure-related message or the second failure-related message means that the message to be reported comprises the first failure-related message and the second failure-related message.

In one embodiment, the phrase that the fourth signaling comprises configuration information of the second serving cell means that the fourth signaling comprises random-access-related information of the second serving cell.

In one embodiment, the phrase that the fourth signaling comprises configuration information of the second serving cell means that the fourth signaling comprises RRC-configuration-related information of the second serving cell.

In one embodiment, the phrase that the fourth signaling comprises configuration information of the second serving cell means that the fourth signaling comprises uplink-synchronization-related information of the second serving cell.

In one embodiment, a transmitter of the fourth signaling includes a maintenance base station for the first serving cell.

In one embodiment, a transmitter of the fourth signaling includes a serving base station for a source cell.

In one embodiment, the fourth signaling is used for configurations for the CHO.

In one embodiment, the fourth signaling is used for configurations for PSCell Conditional Addition (CPA).

In one embodiment, the fourth signaling is used for configurations for PSCell Conditional Change (CPC).

In one embodiment, the fourth signaling is used for configurations for MCG failure recovery.

In one embodiment, the fourth signaling is used for configurations for DAPS handover.

In one embodiment, the fourth signaling is transmitted via an air interface.

In one embodiment, the fourth signaling is transmitted via a wireless interface.

In one embodiment, the fourth signaling is transmitted via a higher layer signaling.

In one embodiment, the fourth signaling comprises a higher layer signaling.

In one embodiment, the fourth signaling comprises all or part of a higher layer signaling.

In one embodiment, the fourth signaling is borne by an SRB1.

In one embodiment, the fourth signaling is borne by a Split SRB1.

In one embodiment, the fourth signaling is borne by an SRB3.

In one embodiment, the fourth signaling comprises a DL signaling.

In one embodiment, a logical channel bearing the fourth signaling includes a DCCH.

In one embodiment, the fourth signaling comprises an RRC message.

In one embodiment, the fourth signaling comprises all or part of IEs in an RRC message.

In one embodiment, the fourth signaling comprises all or part of fields of an IE in an RRC message.

In one embodiment, the fourth signaling comprises an RRCReconfiguration message.

In one embodiment, the fourth signaling comprises an RRCReconfiguration IE.

In one embodiment, the fourth signaling comprises an ConditionalReconfiguration IE.

In one embodiment, the fourth signaling comprises a conditionalReconfiguration field.

In one embodiment, the fourth signaling comprises a condConfigId.

In one embodiment, the fourth signaling comprises an RRCConnectionReconfiguration message.

In one embodiment, the fourth signaling comprises an RRCConnectionReconfigurationIE.

In one embodiment, the fourth signaling comprises a ConditionalReconfiguration IE.

In one embodiment, the fourth signaling comprises a condReconfigurationId field.

In one embodiment, the fourth signaling comprises reconfigurationWithSync.

In one embodiment, the fourth signaling comprises a dapsConfig field.

In one embodiment, the fourth signaling comprises a HandoverPreparationInformation message.

In one embodiment, the fourth signaling comprises a configRestrictInfoDAPS field.

In one embodiment, the fourth signaling comprises dapsHO-Config.

In one embodiment, the fourth signaling comprises a drb-ToAddModList.

In one embodiment, the fourth signaling comprises daps-SourceRelease.

In one embodiment, the first target cell comprises the second serving cell.

In one embodiment, the first target cell comprises a cell determined through Cell Selection.

In one embodiment, the first target cell is used for RRC Connection Reestablishment.

In one embodiment, the third field of the second failure-related message is used for determining an identity of a cell which is used for RRC Reestablishment.

In one embodiment, the third field of the second failure-related message comprises a reestablishmentCellId.

In one embodiment, a receiver of the fifth signaling includes a maintenance base station for the first target cell.

In one embodiment, the fifth signaling is transmitted via an air interface.

In one embodiment, the fifth signaling is transmitted via a wireless interface.

In one embodiment, the fifth signaling is transmitted via a higher layer signaling.

In one embodiment, the fifth signaling comprises a higher layer signaling.

In one embodiment, the fifth signaling comprises all or part of a higher layer signaling.

In one embodiment, the fifth signaling comprises an RRC message.

In one embodiment, the fifth signaling comprises all or part of IEs in an RRC message.

In one embodiment, the fifth signaling comprises all or part of fields of an IE in an RRC message.

In one embodiment, a Signaling Radio Bearer of the fifth signaling includes SRB0.

In one embodiment, a logical channel bearing the fifth signaling includes a CCCH.

In one embodiment, the phrase that the fifth signaling is used for requesting a connection reestablishment includes that the fifth signaling is used for initiating an RRC Reestablishment.

In one embodiment, the phrase that the fifth signaling is used for requesting a connection reestablishment includes that the fifth signaling comprises a first message in an RRC Reestablishment procedure.

In one embodiment, the fifth signaling comprises an RRCReestablishmentRequest message.

In one embodiment, the fifth signaling comprises an RRCConnectionReestablishmentRequest message.

In one embodiment, the meaning of the clearing includes deleting.

In one embodiment, the meaning of the clearing includes discarding.

In one embodiment, the meaning of the clearing includes releasing.

In one embodiment, when the second failure-related message is generated, clear the first failure-related message.

In one embodiment, the phrase of clearing the first failure-related message includes a meaning of clearing all of the first failure-related message stored in the VarRLF-Report.

In one embodiment, the phrase of clearing the first failure-related message includes a meaning of clearing part of the first failure-related message stored in theVarRLF-Report.

In one embodiment, the phrase that the second failure-related message comprises the first failure-related message means that the second failure-related message comprises all of the first failure-related message.

In one embodiment, the phrase that the second failure-related message comprises the first failure-related message means that the second failure-related message comprises part of the first failure-related message.

In one embodiment, the box F1A framed with dotted lines is optional.

In one embodiment, the box F1A framed with dotted lines exists.

In one embodiment, the box F1A framed with dotted lines does not exist.

In one embodiment, when the box F1A framed with dotted lines exists, the third signaling comprises an RRCReestablishmentComplete message.

In one embodiment, when the box F1A framed with dotted lines does not exist, the third signaling comprises an RRCConnectionReestablishmentComplete message.

### Embodiment 5B

Embodiment 5B illustrates a flowchart of radio signal transmission according to one embodiment of the present disclosure, as shown in FIG. 5B. a first node U01B is a user end; a second node N02B is a maintenance base station for a first target cell; and a third node N03B is a maintenance base station for a source cell of the first node U01B; it should be noted particularly that the order illustrated herein does not imply sequence orders of signal transmissions and implementations in the present disclosure.

The first node U01B receives a first signaling in step S5101B, transmits a second signaling in step S5102B, transmits a third signaling in step S5103B, receives a fourth signaling in step S5104B, and transmits a fifth signaling in step S5105B, receives a second message in step S5106B, and transmits a third information set in step S5107B.

The second node N02B receives a second signaling in step S5201B, receives a third signaling in step S5202B, and transmits a fourth signaling in step S5203B, receives a fifth signaling in step S5204B, transmits second information in step S5205B, and receives a third information set in step S5206B.

The third node N03B transmits a first signaling in step S5301B.

In Embodiment 5B, the first signaling indicates a first candidate cell set; as a response to the determined radio connection failure, a first variant set is generated and a first target cell is selected; a first sub-message in the first variant set is configured as an identity of the first target cell; when the first target cell belongs to the first candidate cell set, a type of the first target cell in the first variant set is configured as a first type; when the first target cell is not a candidate cell in the first candidate cell set, a type of the first target cell in the first variant set is configured as a second type; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message; a name of the first sub-message in the first variant set is used to determine the type of the first target cell in the first variant set; the first variant set comprises a second sub-message, the second sub-message being used to indicate the type of the first target cell in the first variant set; the second message is used for requesting the RLF-related message; the third information set comprises a first sub-information-block, the first sub-information-block is related to the RLF-related message, and the first sub-information-block comprises a value of the first variant set; the fourth signaling is used for triggering the fifth signaling, the fifth signaling comprising the first message.

In one embodiment, a transmitter of the first signaling includes a second node N02B.

In one embodiment, a transmitter of the first signaling includes a third node N03B.

In one embodiment, the second node N02B includes a maintenance base station for a CHO candidate cell.

In one embodiment, the second node N02B includes a maintenance base station for a PCell.

In one embodiment, the third node N03B includes a maintenance base station for a PSCell.

In one embodiment, the third node N03B includes a maintenance base station for the first serving cell.

In one embodiment, the radio connection failure occurs between the first node U01B and the second node N02B.

In one embodiment, the radio connection failure occurs between the first node U01B and the third node N03B.

In one embodiment, the first receiver generates the RLF-related message.

In one embodiment, the first transmitter generates the RLF-related message.

In one embodiment, the first node U01B generates the RLF-related message.

In one embodiment, the phrase that a name of the first sub-message in the first variant set is used to determine the type of the first target cell in the first variant set includes a meaning that the type of the first target cell in the first variant set comprises the name of the first sub-message in the first variant set.

In one embodiment, the phrase that a name of the first sub-message in the first variant set is used to determine the type of the first target cell in the first variant set includes a meaning that the name of the first sub-message in the first variant set is used to indicate the type of the first target cell in the first variant set.

In one embodiment, the phrase that a name of the first sub-message in the first variant set is used to determine the type of the first target cell in the first variant set includes a meaning that the type of the first target cell in the first variant set is differentiated by the name of the first sub-message in the first variant set.

In one embodiment, when the first target cell is used for performing reconfiguration of the radio resource control connection, the name of the first sub-message is associated with the first type.

In one embodiment, when the first target cell belongs to the first candidate cell set, a first sub-message in the first variant set is configured as an identity of the first target cell, a type of the first target cell in the first variant set is configured as a first type, and a name of the first sub-message in the first variant set is used to determine the type of the first target cell in the first variant set.

In one embodiment, when the first target cell belongs to the first candidate cell set, the name of the first sub-message comprises a first name, and the first name is used to indicate that the type of the first target cell in the first variant set is a first type.

In one subembodiment, the first name indicates that the first target cell is related to the first type.

In one subembodiment, the first name indicates that the first target cell is related to CHO.

In one subembodiment, the first name indicates that the first target cell is related to conditional configuration.

In one subembodiment, the first name indicates that the first target cell is related to RRC Connection Reconfiguration.

In one subembodiment, the first name indicates that the first target cell is related to RLF recovery.

In one subembodiment, the first name comprises a conditionalhandoverCellId.

In one subembodiment, the first name comprises a conditionhandoverCellId.

In one subembodiment, the first name comprises a conditionalconfigurationCellId.

In one subembodiment, the first name comprises a recoveryCellId.

In one subembodiment, the first name comprises a previousPCellId.

In one subembodiment, the first name comprises a failedPCellId

In one subembodiment, the first name comprises a selectedCellId.

In one subembodiment, the first name comprises a reestablishmentCellId.

In one embodiment, when the first target cell is used for performing reestablishment of the radio resource control connection, the name of the first sub-message is associated with the second type.

In one embodiment, when the first target cell is not a candidate cell in the first candidate cell set, a first sub-message in the first variant set is configured as an identity of the first target cell, and a type of the first target cell in the first variant set is configured as a second type, and a name of the first sub-message in the first variant set is used to determine the type of the first target cell in the first variant set.

In one embodiment, when the first target cell is not a candidate cell in the first candidate cell set, the name of the first sub-message comprises a second name, and the second name is used to indicate that the type of the first target cell in the first variant set is a second type.

In one subembodiment, the second name indicates that the first target cell is related to the second type.

In one subembodiment, the second name indicates that the first target cell is related to RRC Connection Reestablishment.

In one subembodiment, the second name comprises a reestablishmentCellId.

In one subembodiment, the second name comprises a conditionalhandoverCellId.

In one subembodiment, the second name comprises a conditionhandoverCellId.

In one subembodiment, the second name comprises a conditionalconfigurationCellId.

In one subembodiment, the second name comprises a recoveryCellId.

In one subembodiment, the second name comprises a previousPCellId.

In one subembodiment, the second name comprises a failedPCellId.

In one subembodiment, the second name comprises a selectedCellId.

In one embodiment, the previousPCellId is used to determine that the type of the first target cell in the first variant set is a first type; the reestablishmentCellId is used to determine that the type of the first target cell in the first variant set is a second type.

In one embodiment, the failedPCellId is used to determine that the type of the first target cell in the first variant set is a first type; the reestablishmentCellId is used to determine that the type of the first target cell in the first variant set is a second type.

In one subembodiment, when the first target cell belongs to the first candidate cell set, a connectionFailureType in the first information block is configured as an RLF.

In one embodiment, when the first target cell belongs to the first candidate cell set, the first variant set comprises the first sub-message but not the second sub-message; when the first target cell is not a candidate cell in the first candidate cell set, the second variant set comprises the first sub-message but not the second sub-message.

In one embodiment, the second sub-message indicates whether the first target cell is a CHO candidate cell.

In one embodiment, the second sub-message indicates whether the first target cell is a cell comprised in the first candidate cell set.

In one embodiment, the second sub-message indicates functions of the first target cell.

In one embodiment, the second sub-message indicates that the first target cell is used for RRC Connection Reestablishment.

In one embodiment, the second sub-message indicates that the first target cell is used for CHO.

In one embodiment, the second sub-message indicates the type of the first target cell in the RLF-related message from the first type and the second type.

In one embodiment, the second sub-message indicates a type of reestablishment of the radio resource control connection.

In one embodiment, the second sub-message comprises a field in the first variant set.

In one embodiment, the second sub-message's value comprises a value of an enumeration type.

In one embodiment, the second sub-message comprises one or more fields in the first variant set.

In one embodiment, the first variant set's value comprises a second sub-message.

In one embodiment, a name of the second sub-message in the first variant set comprises a reestablishmentType.

In one embodiment, a name of the second sub-message in the first variant set comprises a reestablishmentCellIdType.

In one embodiment, a name of the second sub-message in the first variant set comprises a selectedCellIdType.

In one embodiment, a name of the second sub-message in the first variant set comprises a selectedCellType.

In one embodiment, a name of the second sub-message in the first variant set comprises a recoveryType.

In one embodiment, the value of the second sub-message comprises a first type (type1).

In one embodiment, the value of the second sub-message comprises a second type (type2).

In one embodiment, the value of the second sub-message comprises reestablishment.

In one embodiment, the value of the second sub-message comprises conditionalHandover.

In one embodiment, the value of the second sub-message comprises conditionalConfiguration.

In one embodiment, the value of the second sub-message comprises cho.

In one embodiment, the value of the second sub-message comprises recovery.

In one embodiment, the value of the second sub-message comprises MCGrecovery.

In one embodiment, when the second sub-message exists, the name of the first sub-message is not used for differentiating the type of the first target cell.

In one embodiment, when the second sub-message exists, the name of the first sub-message comprises a reestablishmentCellId.

In one embodiment, when the second sub-message exists, the name of the first sub-message comprises a selectedCellId.

In one embodiment, when the second sub-message exists, the name of the first sub-message comprises a recoveryCellId.

In one embodiment, when a type of the first target cell in the first variant set is configured as a first type, the second sub-message exists.

In one embodiment, when a type of the first target cell in the first variant set is configured as a first type, the second sub-message does not exist.

In one embodiment, when a type of the first target cell in the first variant set is configured as a second type, the second sub-message exists.

In one embodiment, when a type of the first target cell in the first variant set is configured as a second type, the second sub-message does not exist.

In one embodiment, the fourth signaling is transmitted via an air interface.

In one embodiment, the fourth signaling is transmitted via a wireless interface.

In one embodiment, the fourth signaling is transmitted via a higher layer signaling.

In one embodiment, the fourth signaling comprises a higher layer signaling.

In one embodiment, the fourth signaling comprises all or part of a higher layer signaling.

In one embodiment, the fourth signaling comprises an RRC Message.

In one embodiment, the fourth signaling comprises all or part of IEs in an RRC message.

In one embodiment, the fourth signaling comprises all or part of fields of an IE in an RRC message.

In one embodiment, a Signaling Radio Bearer of the fourth signaling includes SRB0.

In one embodiment, a Signaling Radio Bearer of the fourth signaling includes SRB1.

In one embodiment, a logical channel bearing the fourth signaling includes a DCCH.

In one embodiment, a logical channel bearing the fourth signaling includes a CCCH.

In one embodiment, the fourth signaling is used for reestablishing an SRB1.

In one embodiment, the fourth signaling comprises an RRCReestablishment message.

In one embodiment, the fourth signaling comprises an RRCConnectionReestablishment message.

In one embodiment, the phrase that the fourth signaling is used for triggering the fifth signaling means that as a response to receiving the fourth signaling, the fifth signaling is transmitted.

In one embodiment, the phrase that the fourth signaling is used for triggering the fifth signaling means that the fifth signaling is used for acknowledging for the fourth signaling.

In one embodiment, when the first target cell is not a candidate cell in the first candidate cell set, the first node U01B receives the fourth signaling and transmits the fifth signaling.

In one embodiment, when the first target cell is a candidate cell in the first candidate cell set, the first node U01B does not receive the fourth signaling or transmit the fifth signaling.

In one embodiment, the fifth signaling is transmitted via an air interface.

In one embodiment, the fifth signaling is transmitted via a wireless interface.

In one embodiment, the fifth signaling is transmitted via a higher layer signaling.

In one embodiment, the fifth signaling comprises a higher layer signaling.

In one embodiment, the fifth signaling comprises all or part of a higher layer signaling.

In one embodiment, the fifth signaling comprises an RRC message.

In one embodiment, the fifth signaling comprises all or part of IEs in an RRC message.

In one embodiment, the fifth signaling comprises all or part of fields of an IE in an RRC message.

In one embodiment, the fifth signaling is used for an RRC Connection Reestablishment procedure.

In one embodiment, the fifth signaling is used for determining a successful completion of the RRC Connection Reestablishment.

In one embodiment, a Signaling Radio Bearer of the fifth signaling includes SRB1.

In one embodiment, the fifth signaling comprises an Uplink (UL) signaling.

In one embodiment, a logical channel bearing the fifth signaling includes a DCCH.

In one embodiment, the fifth signaling comprises an RRCReestablishmentComplete message.

In one embodiment, the fifth signaling comprises an RRCConnectionReestablishmentComplete message.

In one embodiment, the fifth signaling comprises the first message in the present disclosure.

In one embodiment, the fifth signaling comprises a rlf-InfoAvailable field.

In one embodiment, the second message is transmitted via an air interface.

In one embodiment, the second message is transmitted via a wireless interface.

In one embodiment, the second message is transmitted via a higher layer signaling.

In one embodiment, the second message comprises a higher layer signaling.

In one embodiment, the second message comprises all or part of a higher layer signaling.

In one embodiment, the second message comprises an RRC message.

In one embodiment, the second message comprises all or part of IEs in an RRC message.

In one embodiment, the second message comprises all or part of fields of an IE in an RRC message.

In one embodiment, the second message comprises a DL signaling.

In one embodiment, a Signaling Radio Bearer of the second message includes SRB1.

In one embodiment, a logical channel bearing the second message includes a DCCH.

In one embodiment, the second message is used for requesting UE Information.

In one embodiment, the second message is used for requesting an RLF-related message.

In one embodiment, the second message comprises a UEInformationRequest message.

In one embodiment, the second message comprises an RLF-ReportReq IE.

In one embodiment, the second message is used for triggering transmission of the third information set.

In one embodiment, the phrase that the second message is used for requesting the RLF-related message means that a field in the second message is used for determining the RLF-related message.

In one embodiment, the second message is used for determining a request for the RLF-related message.

In one embodiment, the second message is used for determining a request for a message related to successful handover.

In one embodiment, the second message comprises a rlf-ReportReq field.

In one embodiment, the second message comprises a successHandover-ReportReq field.

In one embodiment, the second message comprises a rlfRecovery-ReportReq field.

In one subembodiment, when the field is configured as true, the field is used for requesting the RLF-related message.

In one subembodiment, when the field is not configured as true, the field is not used for requesting the RLF-related message.

In one embodiment, a receiver of the third information set is the same as a transmitter of the second message.

In one embodiment, the third information set is transmitted via an air interface.

In one embodiment, the third information set is transmitted via a wireless interface.

In one embodiment, the third information set is transmitted via a higher layer signaling.

In one embodiment, the third information set comprises a higher layer signaling.

In one embodiment, the third information set comprises all or part of a higher layer signaling.

In one embodiment, the third information set comprises an RRC message.

In one embodiment, the third information set comprises all or part of IEs in an RRC message.

In one embodiment, the third information set comprises all or part of fields of an IE in an RRC message.

In one embodiment, the third information set comprises a UL message.

In one embodiment, the third information set is used for UE Information Response.

In one embodiment, the third information set is used for reporting an RLF-related message.

In one embodiment, a Signaling Radio Bearer of the third information set includes SRB1.

In one embodiment, a Signaling Radio Bearer of the third information set includes SRB2.

In one embodiment, a logical channel bearing the third information set includes a DCCH.

In one embodiment, the third information set comprises a UEInformationResponse message.

In one embodiment, the third information set comprises an RLF-Report field.

In one embodiment, the third information set comprises an nr-RLF-Report field.

In one embodiment, the third information set comprises a eutra-RLF-Reportfield.

In one embodiment, the third information set comprises a rlf-Report field.

In one embodiment, the phrase that the third information set comprises a first sub-information-block means that the third information set comprises all or part of the first sub-information-block.

In one embodiment, the phrase that the third information set comprises a first sub-information-block means that the first sub-information-block is one or more fields in the third information set.

In one embodiment, the phrase that the third information set comprises a first sub-information-block means that the first sub-information-block is one or more IEs in the third information set.

In one embodiment, the first sub-information-block comprises a rlf-Report field.

In one embodiment, the first sub-information-block comprises an RLF-Report field.

In one embodiment, the first sub-information-block comprises a successHandover-ReportReq field.

In one embodiment, the first sub-information-block comprises a rlfRecovery-ReportReq field.

In one embodiment, the phrase that the first sub-information-block is related to the RLF-related message means that the first sub-information-block comprises all of the RLF-related message.

In one embodiment, the phrase that the first sub-information-block is related to the RLF-related message means that the first sub-information-block comprises part of the RLF-related message.

In one embodiment, the phrase that the first sub-information-block is related to the RLF-related message means that the first sub-information-block is set according to the RLF-related message.

In one embodiment, the phrase that the first sub-information-block is related to the RLF-related message means that the first sub-information-block is used for carrying the RLF-related message.

In one embodiment, the phrase that the first sub-information-block comprises a value of the first variant set means that the first sub-information-block in the third information set is set according to the value in the first variant set.

In one embodiment, the phrase that the first sub-information-block comprises a value of the first variant set means that a value of the first sub-information-block in the third information set is set as the value in the first variant set.

In one embodiment, the value of the first variant set comprises a rlf-Report.

In one embodiment, the value of the first variant set comprises the RLF-related message stored in the first variant set.

In one embodiment, the second message is used for requesting the RLF-related message; the third information set comprises a first sub-information-block, the first sub-information-block is related to the RLF-related message, and the first sub-information-block comprises the value of the first variant set.

In one embodiment, the phrase that the first sub-information-block comprises a value of the first variant set includes a meaning as follows: configuring the first sub-information-block as the value of the first variant set.

In one embodiment, the box F1B framed with dotted lines is optional.

In one embodiment, the box F2B framed with dotted lines is optional.

In one embodiment, the box F1B framed with dotted lines exists, while the box F2B framed with dotted lines does not exist.

In one embodiment, the box F1B framed with dotted lines does not exist, while the box F2B framed with dotted lines exists.

In one embodiment, when the first node U01B does not select a proper cell, neither the dotted-line box F1B nor the dotted-line box F2B exists, and the first node U01B enters in an IDLE state.

### Embodiment 6A

Embodiment 6A illustrates a schematic diagram of a first failure-related message and a second failure-related message being generated and transmitted according to one embodiment of the present disclosure.

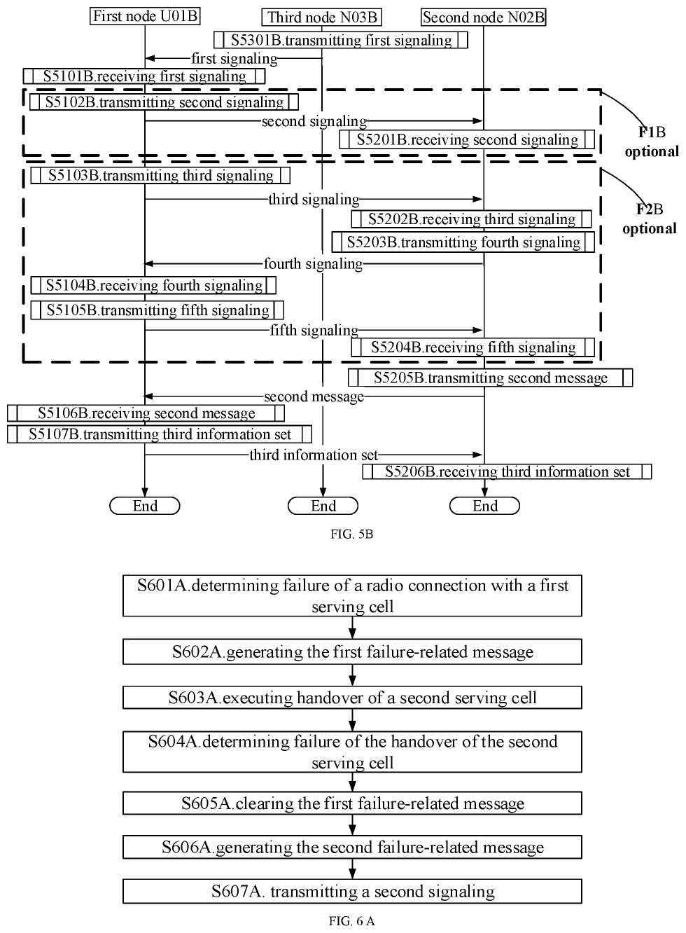

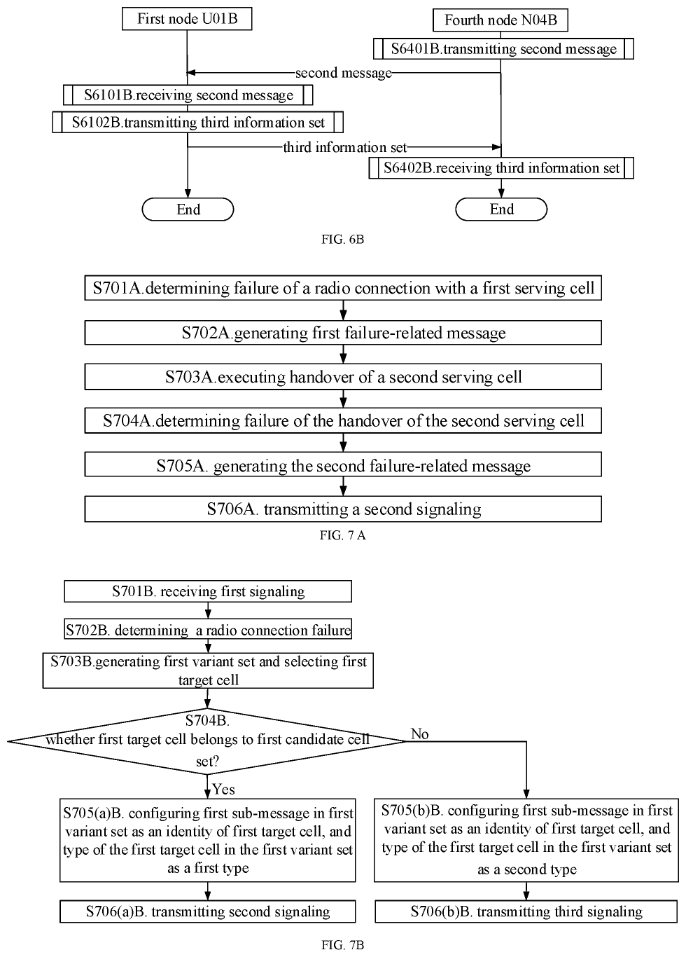

As shown in FIG. 6A, a first node determines a failure of a radio connection with a first serving cell in step S601A, generates the first failure-related message in step S602A; and executes a handover of a second serving cell in step S603A, determines a failure of the handover of the second serving cell in step S604A, clears the first failure-related message in step S605A, generates the second failure-related message in step S606A, and transmits a second signaling in step S607A. Herein, the second signaling comprises the second failure-related message.

In one embodiment, the phrase of “generates the first failure-related message in step S602A” includes storing the first failure-related message in a VarRLF_Report.

In one embodiment, the phrase of “clears the first failure-related message in step S605A” includes clearing the first failure-related message stored in the VarRLF_Report.

In one subembodiment, all of the first failure-related message stored in the VarRLF_Report is cleared.

In one subembodiment, part of the first failure-related message stored in the VarRLF_Report is cleared.

In one embodiment, the phrase of “generates the second failure-related message in step S606A” includes storing the second failure-related message in the VarRLF_Report.

In one embodiment, the second failure-related message comprises the first failure-related message.

In one subembodiment, the phrase that the second failure-related message comprises the first failure-related message includes: the second failure-related message comprises all of the first failure-related message.

In one subembodiment, the phrase that the second failure-related message comprises the first failure-related message includes: the second failure-related message comprises part of the first failure-related message.

In one subembodiment, the phrase that the second failure-related message comprises the first failure-related message includes: storing all of the first failure-related message in the VarRLF_Report.

In one subembodiment, the phrase that the second failure-related message comprises the first failure-related message includes: storing part of the first failure-related message in the VarRLF_Report.

In one embodiment, the second failure-related message does not comprise the first failure-related message.

In one subembodiment, the phrase that the second failure-related message does not comprise the first failure-related message includes: the first failure-related message is completely cleared, and will not be stored in the VarRLF_Report.

In one embodiment, the phrase that the second signaling comprises the second failure-related message includes that the second signaling comprises the second failure-related message stored in the VarRLF_Report.

In one embodiment, the phrase that the second signaling comprises the second failure-related message includes that the second signaling comprises the second failure-related message and the first failure-related message.

In one embodiment, the phrase that the second signaling comprises the second failure-related message includes that the second signaling comprises all of the second failure-related message and part of the first failure-related message.

### Embodiment 6B

Embodiment 6B illustrates a schematic diagram of transmission of a second message and a third information set according to one embodiment of the present disclosure, as shown in FIG. 6B. In FIG. 6B, each box represents a step. It should be noted particularly that the order in which the boxes are arranged does not imply a chronological sequence of each step respectively marked.

The first node U01B receives a second message in step S6101B and transmits a third information set in step S6102B.

The fourth node N04B transmits a second message in step S6401B and receives a third information set in step S6402B.

In one embodiment, the fourth node N04B is the same as the second node N02B in the present disclosure.

In one embodiment, the fourth node N04B is different from the second node N02B in the present disclosure.

In one embodiment, the fourth node N04B is the same as the third node N03B in the present disclosure.

In one embodiment, the fourth node N04B is different from the third node N03B in the present disclosure.

In one embodiment, the fourth node N04B comprises a maintenance base station for serving cell currently in connection with the first node U01B.

In one subembodiment, the serving cell currently in connection with the first node U01B is different from the first target cell.

In one subembodiment, the serving cell currently in connection with the first node U01B is the same as the first target cell.

In one subembodiment, the serving cell currently in connection with the first node U01B is different from the first serving cell.

In one subembodiment, the serving cell currently in connection with the first node U01B is the same as the first serving cell.

### Embodiment 7A

Embodiment 7A illustrates a schematic diagram of a first failure-related message and a second failure-related message being generated and transmitted according to another embodiment of the present disclosure.

As shown in FIG. 7A, a first node determines a failure of a radio connection with a first serving cell in step S701A, generates the first failure-related message in step S702A, executes a handover of a second serving cell in step S703A, and determines a failure of the handover of the second serving cell in step S704A, generates the second failure-related message in step S705A, and transmits a second signaling in step S706A.

Herein, the second signaling comprises the first failure-related message and the second signaling comprises the second failure-related message.

In one embodiment, the phrase of “generates the first failure-related message in step S702A” includes storing the first failure-related message in a VarRLF_Report.

In one embodiment, the phrase of “generates the second failure-related message in step S705A” includes storing the second failure-related message in the VarRLF_Report.

In one embodiment, the first failure-related message and the second failure-related message are both stored in the VarRLF_Report.

In one embodiment, the phrase that the second signaling comprises the first failure-related message and the second signaling comprises the second failure-related message includes that the second signaling comprises the first failure-related message and the second failure-related message at the same time.

In one embodiment, the first failure-related message and the second failure-related message are stored in an RLF report list, and the RLF report list is used for storing multiple RLF reports.

In one embodiment, the RLF report list comprises a field in the VarRLF_Report.

### Embodiment 7B

Embodiment 7B illustrates a schematic diagram of a procedure of a first variant set being configured according to one embodiment of the present disclosure, as shown in FIG. 7B. In FIG. 7B, each box represents a step. It should be noted particularly that the order in which the boxes are arranged does not imply a chronological sequence of each step respectively marked.

In Embodiment 7B, a first node receives a first signaling in step S701B; determines a radio connection failure in step S702B; generates a first variant set and selects a first target cell in step S703B; and determines in step S704B whether the first target cell belongs to a first candidate cell set; if the first target cell belongs to the first candidate cell, configures a first sub-message in the first variant set as an identity of the first target cell, and a type of the first target cell in the first variant set as a first type in step S705(a) B; transmits a second signaling in step S706(a) B; if the first target cell does not belong to the first candidate cell set, configures a first sub-message in the first variant set as an identity of the first target cell, and a type of the first target cell in the first variant set as a second type in S705(b) B; and transmits a third signaling in step S706(b) B.

In one embodiment, the step S705(a) B and the step S706(a) B are taken simultaneously.

In one embodiment, the step S705(a) B is taken before the step S706 (a) B.

In one embodiment, the step S705(a) B is taken after the step S706 (a) B.

In one embodiment, the step S705(b) B and the step S706 (b) B are taken simultaneously.

In one embodiment, the step S705(b) B is taken before the step S706 (b) B.

In one embodiment, the step S705(b) B is taken after the step S706 (b) B.

In one embodiment, the action of generating the first variant set is before the action of selecting the first target cell.

In one embodiment, the action of generating the first variant set is after the action of selecting the first target cell.

In one embodiment, the action of generating the first variant set and the action of selecting the first target cell occur simultaneously.

In one embodiment, when a first node determines that the first target cell belongs to a first candidate cell set, a first sub-message in the first variant set is configured as an identity of the first target cell, and a type of the first target cell in the first variant set is configured as a first type.

In one subembodiment, the phrase that “when a first node determines that the first target cell belongs to a first candidate cell set” includes when the first node determines that the first target cell is one candidate cell of the first candidate cell set.

In one subembodiment, the phrase that “when a first node determines that the first target cell belongs to a first candidate cell set” includes when the first node determines to execute CHO.

In one subembodiment, the phrase that “when a first node determines that the first target cell belongs to a first candidate cell set” includes when the first node completed an execution of CHO.

In one subembodiment, the phrase that “when a first node determines that the first target cell belongs to a first candidate cell set” includes when the second signaling is transmitted.

In one subembodiment, the phrase that “when a first node determines that the first target cell belongs to a first candidate cell set” includes before the second signaling is transmitted.

In one subembodiment, the phrase that “when a first node determines that the first target cell belongs to a first candidate cell set” includes after the second signaling is transmitted.

In one embodiment, when a first node determines that the first target cell does not belong to a first candidate cell set, a first sub-message in the first variant set is configured as an identity of the first target cell, and a type of the first target cell in the first variant set is a second type.

In one subembodiment, the phrase that “when a first node determines that the first target cell does not belong to a first candidate cell set” includes when the third signaling is transmitted.

In one subembodiment, the phrase that “when a first node determines that the first target cell does not belong to a first candidate cell set” includes after the third signaling is transmitted.

In one subembodiment, the phrase that “when a first node determines that the first target cell does not belong to a first candidate cell set” includes before the third signaling is transmitted.

### Embodiment 8A

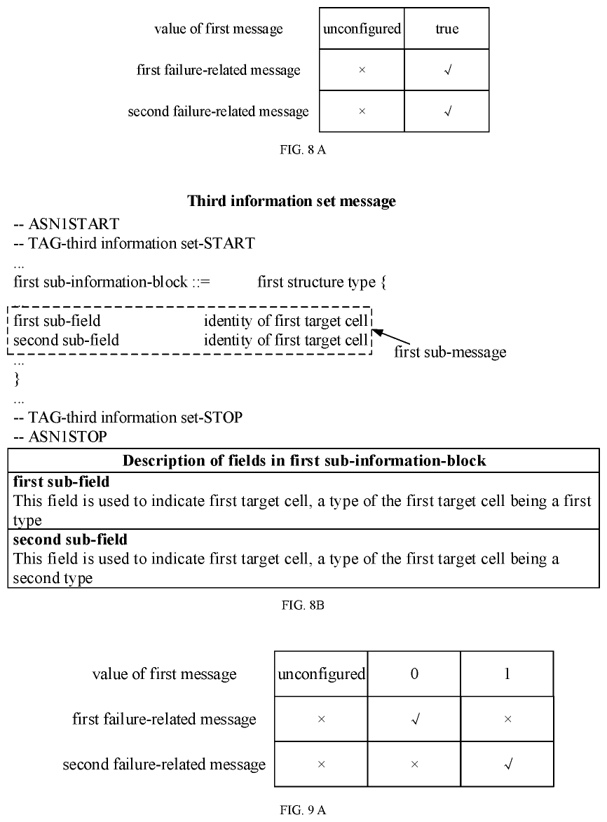

Embodiment 8A illustrates a schematic diagram of a first message of a third signaling being used to indicate generation of a first failure-related message and a second failure-related message according to one embodiment of the present disclosure, as shown in FIG. 8A. In FIG. 8A, a first row represents a value of the first message, the second row represents whether the first failure-related message is generated, and the third row represents whether the second failure-related message is generated; symbol x represents “not being generated”, and symbol ✓ represents “being generated”.

In Embodiment 8A, the first message in the third signaling comprises one bit.

In one embodiment, when the first message is unconfigured, it is indicated that the first failure-related message and the second failure-related message are not generated.

In one embodiment, when the first message is configured as true, it is indicated that the first failure-related message and the second failure-related message are both generated.

In one embodiment, being unconfigured means that the third signaling does not comprise the first message.

### Embodiment 8B

Embodiment 8B illustrates a schematic diagram of a name of a first sub-message in a first variant set being used to determine a type of a first target cell in a first variant set according to one embodiment of the present disclosure, as shown in FIG. 8B. In FIG. 8B, a box framed with dotted lines represents a first sub-message, the first sub-message comprising a first sub-field and a second sub-field; and the solid-line boxes contain descriptions of fields in the first sub-information-block; the ellipsis represents other fields or IEs.

In Embodiment 8B, a name of the first sub-message in the first variant set is used for determining the type of the first target cell in the first variant set; the first sub-message comprises a first sub-field and a second sub-field; the third information set comprises a first sub-information-block, and the first sub-information-block is related to the RLF-related message, the first sub-information-block comprising a value of the first variant set.

In one embodiment, the FIG. 8B is a schematic diagram of a message structure of the third information set.

In one embodiment, the “-- ASN1START” represents a start of ASN.1 message.

In one embodiment, the “-- TAG-third information set-START” represents a start of message in the third information set.

In one embodiment, the “-- TAG-third information set-STOP” represents an end of message in the third information set.

In one embodiment, the “-- ASN1STOP” represents an end of ASN.1 message.

In one embodiment, the first structure type comprises SEQUENCE.

In one embodiment, the first structure type comprises CHOICE.

In one embodiment, the first sub-information-block comprises part of fields in the third information set.

In one embodiment, the first sub-field is used to indicate that a type of the first target cell is a first type.

In one embodiment, the first sub-field is a field in a VarRLF-Report.

In one embodiment, the first sub-field comprises the first name.

In one embodiment, the second sub-field is used to indicate that a type of the first target cell is a second type.

In one embodiment, the second sub-field is a field in a VarRLF-Report.

In one embodiment, the second sub-field comprises the second name.

In one embodiment, when the first target cell belongs to the first candidate cell set, the first sub-field is configured as the identity of the first target cell.

In one embodiment, when the first target cell does not belong to the first candidate cell set, the first sub-field is not configured as the identity of the first target cell.

In one subembodiment, the first sub-field is any value.

In one subembodiment, the first sub-field is a default value.

In one subembodiment, the first sub-field is a preconfigured value.

In one embodiment, when the first target cell is not a candidate cell in the first candidate cell set, a name of the second sub-field is configured as the identity of the first target cell.

In one embodiment, when the first target cell is a candidate cell in the first candidate cell set, a name of the second sub-field is not configured as the identity of the first target cell.

In one subembodiment, the second sub-field is any value.

In one subembodiment, the second sub-field is a default value.

In one subembodiment, the second sub-field is a preconfigured value.

In one embodiment, the first sub-field and the second sub-field are not configured at the same time.

In one embodiment, the first sub-field and the second sub-field are simultaneously configured.

In one embodiment, the first sub-field and the second sub-field are not reported at the same time.

In one embodiment, the first sub-field and the second sub-field are simultaneously reported.

### Embodiment 9A

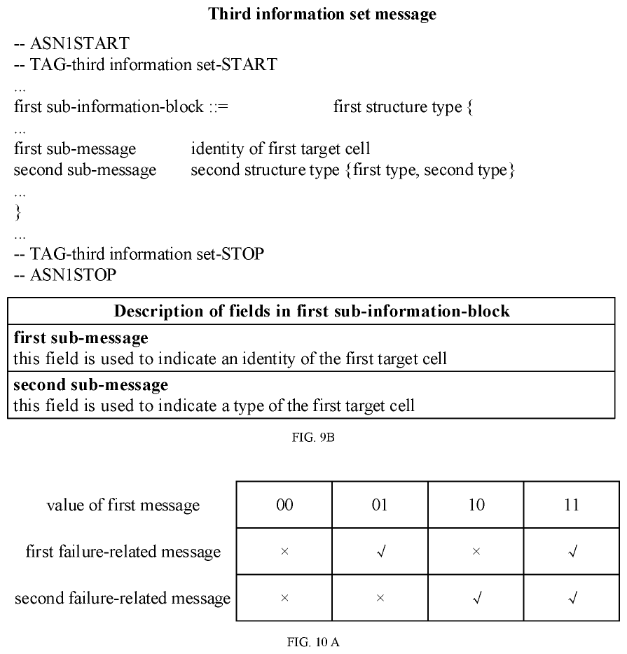

Embodiment 9A illustrates a schematic diagram of a first message of a third signaling being used to indicate generation of a first failure-related message and a second failure-related message according to another embodiment of the present disclosure, as shown in FIG. 9A. In FIG. 9A, a first row represents a value of the first message, the second row represents whether the first failure-related message is generated, and the third row represents whether the second failure-related message is generated; symbol x represents “not being generated”, and symbol ✓ represents “being generated”.

In Embodiment 9A, the first message comprises one bit.

In one embodiment, when the first message is not configured, it is indicated that the first failure-related message and the second failure-related message are not generated.

In one embodiment, when the first message is configured as 0, it is indicated that the first failure-related message is generated and the second failure-related message is not generated.

In one embodiment, when the first message is configured as 1, it is indicated that the first failure-related message is not generated and the second failure-related message is generated.

In one embodiment, being unconfigured means that the third signaling does not comprise the first message.

### Embodiment 9B

Embodiment 9B illustrates a schematic diagram of a second sub-message being used to indicate a type of a first target cell in a first variant set according to one embodiment of the present disclosure, as shown in FIG. 9B. In FIG. 9B, the solid-line boxes contain descriptions of fields in the first sub-information-block; the ellipsis represents other fields or IEs.

In Embodiment 9B, a first sub-message in the first variant set is configured as an identity of the first target cell; the first variant set comprises a second sub-message, the second sub-message being used to indicate a type of the first target cell in the first variant set; a third information set comprises a first sub-information-block, the first sub-information-block is related to the RLF-related message, and the first sub-information-block comprises a value of the first variant set.

In one embodiment, the FIG. 9B is a schematic diagram of a message structure of the third information set.

In one embodiment, the “-- ASN1START” represents a start of ASN.1 message.

In one embodiment, the “-- TAG-third information set-START” represents a start of message in the third information set.

In one embodiment, the “-- TAG-third information set-STOP” represents an end of message in the third information set.

In one embodiment, the “-- ASN1STOP” represents an end of ASN.1 message.

In one embodiment, the first structure type comprises SEQUENCE.

In one embodiment, the first structure type comprises CHOICE.

In one embodiment, the second structure type comprises ENUMERATED.

In one embodiment, the second structure type comprises BOOLEAN.

In one embodiment, the first sub-message is used for indicating an identity of the first target cell.

In one embodiment, the second sub-message is used for indicating a type of the first target cell.

In one embodiment, a value of the second sub-message comprises a first type and a second type.

In one embodiment, when the first target cell belongs to the first candidate cell set, the first variant set comprises the first sub-message and the second sub-message; when the first target cell does not belong to the first candidate cell set, the first variant set comprises the first sub-message and the second sub-message.

In one embodiment, when the first target cell belongs to the first candidate cell set, a first sub-message in the first variant set is configured as an identity of the first target cell, the second sub-message is used for indicating the type of the first target cell in the first variant set, and the type of the first target cell in the first variant set is configured as a first type.

In one embodiment, when the first target cell does not belong to the first candidate cell set, a first sub-message in the first variant set is configured as an identity of the first target cell, the second sub-message is used for indicating the type of the first target cell in the first variant set, and the type of the first target cell in the first variant set is configured as a second type.

### Embodiment 10A

Embodiment 10A illustrates a schematic diagram of a first message of a third signaling being used to indicate generation of a first failure-related message and a second failure-related message according to another embodiment of the present disclosure, as shown in FIG. 10A. In FIG. 10A, a first row represents a value of the first message, the second row represents whether the first failure-related message is generated, and the third row represents whether the second failure-related message is generated; symbol x represents “not being generated”, and symbol ✓ represents “being generated”.

In Embodiment 10A, the first message comprises 2 bits.

In one embodiment, when the first message is configured as 00, it is indicated that the first failure-related message and the second failure-related message are not generated.

In one embodiment, when the first message is configured as 01, it is indicated that the first failure-related message is generated and the second failure-related message is not generated.

In one embodiment, when the first message is configured as 10, it is indicated that the first failure-related message is not generated and the second failure-related message is generated.

In one embodiment, when the first message is configured as 11, it is indicated that the first failure-related message is generated and the second failure-related message is generated.

### Embodiment 10B

Embodiment 10B illustrates a schematic diagram of a first sub-information-block comprising a first condition according to the present disclosure, as shown in FIG. 10B. In FIG. 10B, the solid-line boxes contain descriptions of fields in the first sub-information-block; the ellipsis represents other fields or IEs.

In Embodiment 10B, a first sub-message in the first variant set is configured as an identity of the first target cell; a name of the first sub-message in the first variant set is used for determining the type of the first target cell in the first variant set; when the first target cell belongs to the first candidate cell set, a third sub-message in the first variant set is configured as a first condition; the third information set comprises a first sub-information-block, and the first sub-information-block is related to the RLF-related message, the first sub-information-block comprising a value of the first variant set.

In one embodiment, the FIG. 10B is a schematic diagram of a message structure of the third information set.

In one embodiment, the “-- ASN1START” represents a start of ASN.1 message.

In one embodiment, the “-- TAG-third information set-START” represents a start of message in the third information set.

In one embodiment, the “-- TAG-third information set-STOP” represents an end of message in the third information set.

In one embodiment, the “-- ASN1STOP” represents an end of ASN.1 message.

In one embodiment, the first structure type comprises SEQUENCE.

In one embodiment, the first structure type comprises CHOICE.

In one embodiment, the third sub-message comprises one or more fields in the first variant set.

In one embodiment, a value of the first variant set comprises a first sub-message.

In one embodiment, when the first target cell belongs to the first candidate cell set, the first sub-information-block comprises the first sub-field and the third sub-message.

In one subembodiment, the first sub-field is used for indicating the first target cell, a type of the first target cell being a first type.

In one subembodiment, the third sub-message is used for indicating the first condition.

In one embodiment, when the first target cell does not belong to the first candidate cell set, the first sub-information-block comprises the second sub-field and not the third sub-message.

In one subembodiment, the second sub-field is used for indicating the first target cell, a type of the first target cell being a second type.

In one embodiment, one of the first sub-field and the second sub-field is configured.

In one embodiment, the first sub-field and the third sub-message belong to a same field.

In one embodiment, the first sub-field and the third sub-message are configured simultaneously.

In one embodiment, when the first target cell belongs to the first candidate cell set, the first variant set comprises the first sub-message and the second sub-message; when the first target cell is not a candidate cell in the first candidate cell set, the second variant set comprises the first sub-message but not the second sub-message.

In one embodiment, when the first target cell belongs to the first candidate cell set, a first sub-message in the first variant set is configured as an identity of the first target cell, the second sub-message is used for indicating the type of the first target cell in the first variant set, and the type of the first target cell in the first variant set is configured as a first type.

In one embodiment, when the first target cell is not a candidate cell in the first candidate cell set, a first sub-message in the first variant set is configured as an identity of the first target cell, the type of the first target cell in the first variant set is configured as a second type, and a name of the first sub-message in the first variant set is used for determining the type of the first target cell in the first variant set.

### Embodiment 11A

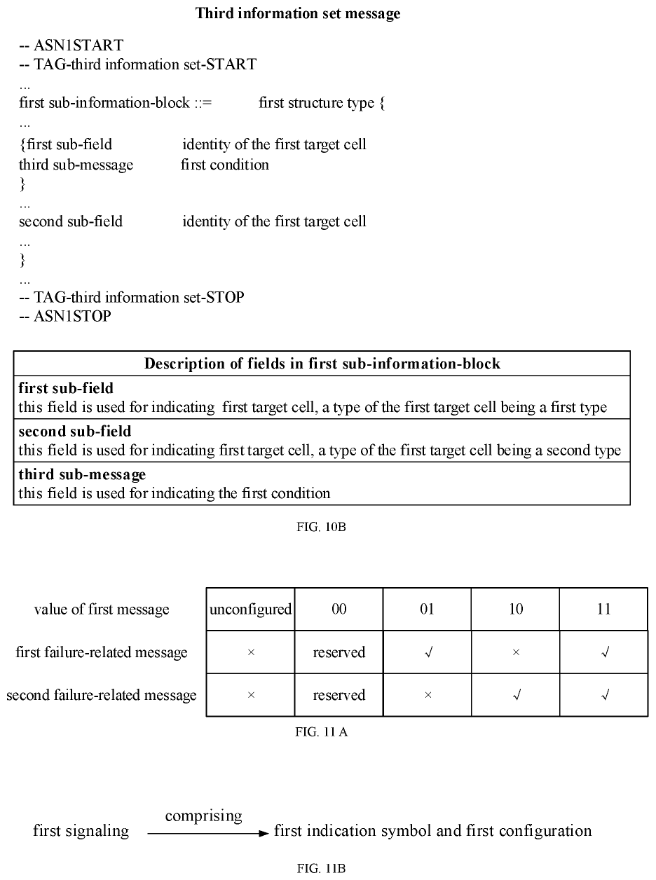

Embodiment 11A illustrates a schematic diagram of a first message of a third signaling being used to indicate generation of a first failure-related message and a second failure-related message according to another embodiment of the present disclosure, as shown in FIG. 11A. In FIG. 11A, a first row represents a value of the first message, the second row represents whether the first failure-related message is generated, and the third row represents whether the second failure-related message is generated; symbol x represents “not being generated”, and symbol ✓ represents “being generated”.

In Embodiment 11A, the first message comprises 2 bits.

In one embodiment, when the first message is not configured, it is indicated that the first failure-related message and the second failure-related message are not generated.

In one embodiment, when the first message is configured as 01, it is indicated that the first failure-related message is generated and the second failure-related message is not generated.

In one embodiment, when the first message is configured as 10, it is indicated that the first failure-related message is not generated and the second failure-related message is generated.

In one embodiment, when the first message is configured as 11, it is indicated that the first failure-related message is generated and the second failure-related message is generated.

In one embodiment, when the first message is configured as 00, it is being reserved.

In one embodiment, the meaning of being reserved is not being defined.

### Embodiment 11B

Embodiment 11B illustrates a schematic diagram of a first signaling comprising a first indication symbol and a first configuration according to one embodiment of the present disclosure, as shown in FIG.

In Embodiment 11B, the first signaling comprises a first indication symbol and a first configuration, the first indication symbol being used to indicate whether the first node is allowed to attempt applying the first configuration; the first configuration is related to the reconfiguration of the radio resource control connection.

In one embodiment, the first signaling comprises a condConfigId field.

In one embodiment, the first signaling comprises a condRRCReconfig field.

In one embodiment, the first signaling comprises a condReconfigurationId field.

In one embodiment, the first signaling comprises a condReconfigurationToApply field.

In one embodiment, the first signaling comprises an attemptCondReconfig field.

In one embodiment, the first signaling comprises an attemptCondReconf field.

In one embodiment, the first indication symbol comprises a field in the first signaling.

In one embodiment, the first indication symbol is used to indicate if a first cell to be selected after the radio connection failure is a cell in the first candidate cell set, the first node is able to execute the first configuration.

In one embodiment, the first indication symbol is configured to indicate that the first node is allowed to attempt executing the first configuration.

In one subembodiment, the phrase “is configured” means being existent.

In one embodiment, the first indication symbol is not configured to indicate that the first node is not allowed to attempt executing the first configuration.

In one subembodiment, the phrase “is not configured” means being non-existent.

In one embodiment, the first configuration is associated with the first target cell, and the first target cell fulfilling the first condition is used for triggering application of the first configuration.

In one embodiment, the first configuration comprises an RRC configuration of the first target cell.

In one embodiment, a first sub-message in the first variant set is configured as an identity of the first target cell; when the first target cell belongs to the first candidate cell set, and the first indication symbol is configured, a type of the first target cell in the first variant set is configured as a first type, and a second signaling is transmitted; when the first target cell belongs to the first candidate cell set, and the first indication symbol is not configured, a type of the first target cell in the first variant set is configured as a second type, and a third signaling is transmitted.

### Embodiment 12A

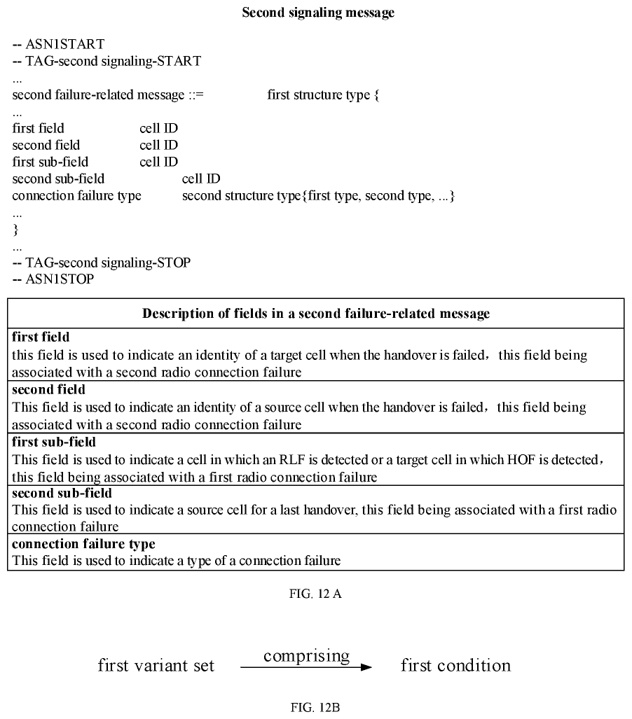

Embodiment 12A illustrates a schematic diagram of a second signaling comprising a first failure-related message and a second failure-related message according to one embodiment of the present disclosure, as shown in FIG. 12A. In FIG. 12A, the solid-line boxes contain descriptions of fields in the second failure-related message; the ellipsis represents other fields or IEs.

In Embodiment 12A, the second signaling comprises the second failure-related message; the second signaling comprises the first failure-related message; the second failure-related message comprises the first failure-related message; a second field of the second failure-related message comprises a cell ID of the first serving cell; and the first field of the second failure-related message comprises a cell ID of the second serving cell; a second sub-field or a first sub-field of the second failure-related message comprises a cell ID of the first serving cell; a second sub-field and a first sub-field of the second failure-related message are related to a type of a first connection failure; the connection failure type includes type1 and type2.

In one embodiment, the FIG. 12A is a schematic diagram of a message structure of the second signaling.

In one embodiment, the “-- ASN1START” represents a start of ASN.1 message.

In one embodiment, the “-- TAG-second signaling-START” represents a start of the second signaling.

In one embodiment, the “-- TAG-second signaling-STOP” represents an end of the second signaling.

In one embodiment, the “-- ASN1STOP” represents an end of ASN.1 message.

In one embodiment, the first structure type comprises SEQUENCE.

In one embodiment, the second structure type comprises ENUMERATED.

In one embodiment, the first failure-related message is generated and stored.

In one embodiment, the first failure-related message is generated but not stored.

In one embodiment, the first failure-related message is stored in the second failure-related message.

In one embodiment, the first failure-related message comprises a first field, and the first field comprised in the first failure-related message comprises an identity of the first serving cell.

In one embodiment, a first field of the second failure-related message comprises a failedPCellId2.

In one embodiment, a second field of the second failure-related message comprises a previousPCellId2.

In one embodiment, a first sub-field of the second failure-related message comprises a failedPCellId1.

In one embodiment, a second sub-field of the second failure-related message comprises a previousPCellId1.

In one embodiment, a first field of the second failure-related message is used to indicate an identity of a target cell when the handover is failed.

In one embodiment, a second field of the second failure-related message is used to indicate an identity of a source cell when the handover is failed.

In one embodiment, the first field of the second failure-related message and the second field of the second failure-related message are associated with a second radio connection failure.

In one embodiment, a first sub-field of the second failure-related message indicates a cell in which an RLF is detected or a target cell in which HOF is detected.

In one embodiment, a second sub-field of the second failure-related message is used to indicate a source cell for a last handover.

In one embodiment, the first sub-field and the second sub-field of the second failure-related message are associated with a first radio connection failure.

In one embodiment, the first sub-field of the second failure-related message comprises the first field of the first failure-related message.

In one embodiment, the second sub-field of the second failure-related message comprises the first field of the first failure-related message.

In one embodiment, when the type of the first connection failure includes RLF, the first sub-field of the second failure-related message comprises an identity of the first serving cell.

In one embodiment, when the type of the first connection failure includes HOF, the second sub-field of the second failure-related message comprises an identity of the first serving cell.

In one embodiment, the connection failure type is used for indicating the type of a connection failure.

### Embodiment 12B

Embodiment 12B illustrates a schematic diagram of a first variant set comprising a first condition according to one embodiment of the present disclosure, as shown in FIG. 12B.

In Embodiment 12B, when the first target cell belongs to the first candidate cell set, a third sub-message in the first variant set is configured as a first condition, the first condition being used to determine conditions for application of the first configuration, and the first signaling indicates the first condition.

In one embodiment, the phrase that the first signaling indicates the first condition includes a meaning that the first signaling comprises the first condition.

In one embodiment, the phrase that the first signaling indicates the first condition includes a meaning that the first condition is one or more fields in the first signaling.

In one embodiment, the first signaling comprises a condExecutionCond field.

In one embodiment, the first signaling comprises a triggerCondition field.

In one embodiment, the third sub-message comprises one or more fields in the first variant set.

In one embodiment, the phrase that a third sub-message in the first variant set is configured as a first condition includes a meaning that the third sub-message is related to the first condition.

In one embodiment, the phrase that a third sub-message in the first variant set is configured as a first condition includes a meaning that the third sub-message comprises the first condition.

In one embodiment, the first condition is used for determining an execution condition for applying the first configuration.

In one embodiment, the first condition comprises one or more triggering conditions.

In one embodiment, the first condition comprises one or two triggering conditions.

In one embodiment, the first condition comprises an A3 event.

In one embodiment, the first condition comprises an A5 event.

In one embodiment, the first condition comprises an execution threshold.

In one embodiment, the first condition comprises a conditional configuration ID.

In one embodiment, the first condition comprises all of execution conditions.

In one embodiment, the first condition comprises some of execution conditions.

### Embodiment 13A

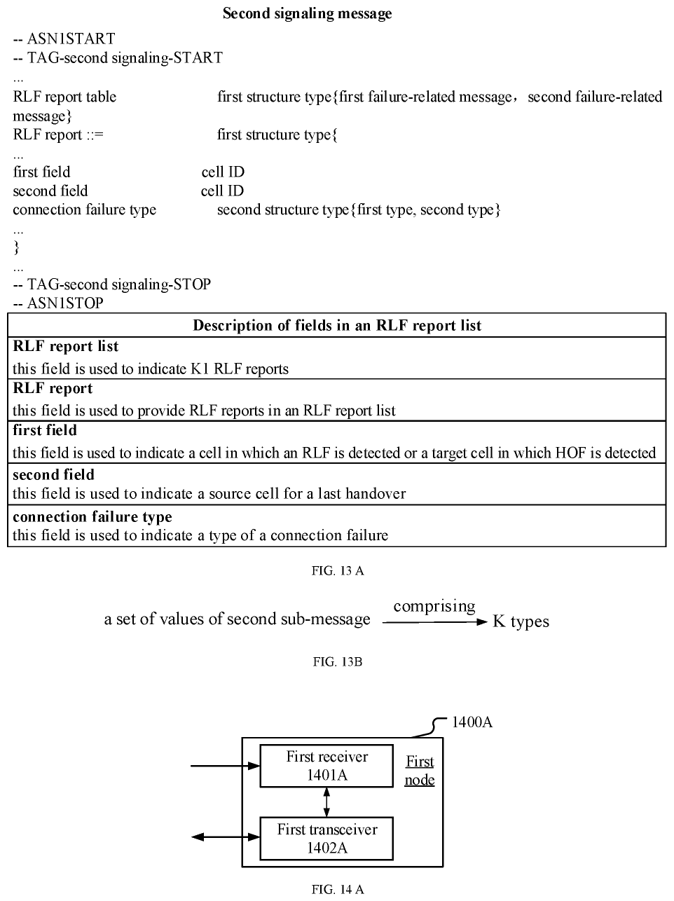

Embodiment 13A illustrates a schematic diagram of a second signaling comprising a first failure-related message and a second failure-related message according to another embodiment of the present disclosure, as shown in FIG. 13A. In FIG. 13A, the solid-line boxes contain descriptions of fields in the second failure-related message; the ellipsis represents other fields or IEs.

In Embodiment 13A, the second signaling comprises an RLF report list, and the RLF report list is used for storing multiple RLF reports; the first failure-related message and the second failure-related message are generated; the second signaling comprises the second failure-related message; the second signaling comprises the first failure-related message; the first failure-related message comprises a first field, and the first field comprised in the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the FIG. 13A is a schematic diagram of a message structure of the second signaling.

In one embodiment, the “-- ASN1START” represents a start of ASN.1 message.

In one embodiment, the “-- TAG-second signaling-START” represents a start of the second signaling.

In one embodiment, the “-- TAG-second signaling-STOP” represents an end of the second signaling.

In one embodiment, the “-- ASN1STOP” represents an end of ASN.1 message.

In one embodiment, the first structure type comprises SEQUENCE.

In one embodiment, the second structure type comprises ENUMERATED.

In one embodiment, the second signaling comprises an RLF report list, and the RLF report list comprises the first failure-related message and the second failure-related message.

In one embodiment, the RLF-related report list is used for storing continuously occurred RLF-related reports that are not yet reported.

In one embodiment, the RLF-related report list is used for storing multiple times of RLF-related reports occurring in a same procedure.

In one embodiment, the RLF-related report list stores an RLF-related report of a failed CHO performed after the occurrence of an RLF.

In one embodiment, the RLF-related report list stores an RLF-related report of a failed CHO performed after the occurrence of a HOF.

In one embodiment, the RLF-related report list comprises K1 RLF reports, K1 being a positive integer greater than 1.

In one subembodiment, the first failure-related message comprises one of the K1 RLF reports.

In one subembodiment, the second failure-related message comprises one of the K1 RLF reports.

In one subembodiment, K1 is no greater than 8.

In one subembodiment, K1 is preconfigured.

In one subembodiment, K1 is configurable.

In one subembodiment, K1 is fixed.

In one embodiment, the RLF-related report list comprises a rlf-ReportList.

In one embodiment, the RLF report comprises a rlf-Report.

In one embodiment, the second signaling comprises a failure-related message list, and the failure-related message list comprises K1 first-type failure-related messages, K1 being a positive integer.

In one subembodiment, the second signaling comprises a rlf-ReportList.

In one subembodiment, the second signaling comprises a rlf-Report.

In one embodiment, the failure-related message list is stored in a VarRLF_Report.

In one subembodiment, the first failure-related message comprises a rlf-Report in a VarRLF_Report.

In one subembodiment, the second failure-related message comprises a rlf-Report in a VarRLF_Report.

In one subembodiment, the phrase of generating a first failure-related message includes storing the first failure-related message in a rlf-Report field in a rlf-ReportList in a VarRLF_Report.

In one subembodiment, the phrase of generating a second failure-related message includes storing the first failure-related message in a rlf-Report field in a rlf-ReportList in a VarRLF_Report.

In one embodiment, an RLF report list field is used for indicating K1 RLF reports.

In one embodiment, the RLF report list field is used for providing RLF reports in an RLF report list.

In one embodiment, the first field is used to indicate a cell in which an RLF is detected or a target cell in which HOF is detected.

In one embodiment, t is used to indicate a source cell for a last handover.

In one embodiment, the connection failure type is used for indicating the type of a connection failure.

### Embodiment 13B

Embodiment 13B illustrates a schematic diagram of a set of values of a second sub-message comprising K types according to one embodiment of the present disclosure, as shown in FIG. 13B.

In Embodiment 13B, the set of values of the second sub-message comprises K types, and one of the K types is used to indicate the type of the first target cell in the first variant set in the present disclosure; the first type and the second type are respectively two types of the K types.

In one embodiment, K is a positive integer greater than 2.

In one embodiment, the phrase that the set of values of the second sub-message comprises K types includes a meaning that the value of the second sub-message comprises a type of the K types.

In one embodiment, the phrase that the set of values of the second sub-message comprises K types includes a meaning that the second sub-message is set to one of the K types.

In one embodiment, the K types are used to determine different functions of the first target cell.

In one embodiment, the K types are used to determine different procedures executed after the first target cell is selected.

In one embodiment, one of the K types is used to determine that a procedure of reestablishment of the radio resource control is executed after the first target cell is selected.

In one embodiment, one of the K types is used to determine that a procedure of reconfiguration of the radio resource control is executed after the first target cell is selected.

In one embodiment, one of the K types is used to determine that a procedure of recovery of the radio connection failure is executed after the first target cell is selected.

In one embodiment, one of the K types is used to determine that a procedure of CHO is executed after the first target cell is selected.

In one embodiment, one of the K types is used to determine that a procedure of Fast MCG Recovery is executed after the first target cell is selected.

In one embodiment, one of the K types is used to determine that the first node enters in an IDLE state.

In one embodiment, the word “determine” means indicating.

In one embodiment, the other sub-message in the RLF-related message indicates the type of the first target cell in the RLF-related message out of the K types, K being a positive integer greater than 2, and the first type and the second type being two different types among the K types.

### Embodiment 14A

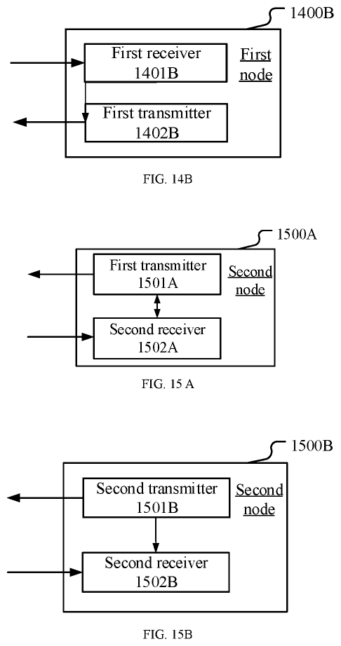

Embodiment 14A illustrates a structure block diagram of a processing device in a first node according to one embodiment of the present disclosure; as shown in FIG. 14A. In FIG. 14A, a processing device 1400A in a first node comprises a first receiver 1401A and a first transceiver 1402A.

The receiver 1401A determines a failure of a radio connection with a first serving cell; and generates a first failure-related message and selects a second serving cell as a response to the determined failure of the radio connection with the first serving cell.

The first transceiver 1402A executes a handover of the second serving cell.

The receiver 1401A determines a failure of the handover of the second serving cell; and generates a second failure-related message as a response to the failure of the handover of the second serving cell.

The first transceiver 1402A receives a first signaling; and transmits a second signaling.

In Embodiment 14A, the first signaling is received after generating the second failure-related message, the first signaling is used for triggering the second signaling, and the second signaling comprises the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the second signaling comprises the first failure-related message.

In one embodiment, the first transceiver 1402A transmits a third signaling; herein, the third signaling comprises a first message, the first message being used for indicating that the first failure-related message and the second failure-related message are generated.

In one embodiment, the first signaling indicates a message to be reported, and the second signaling comprises the message to be reported, the message to be reported comprising at least one of the first failure-related message or the second failure-related message.

In one embodiment, the first receiver 1401A receives a fourth signaling; herein, the fourth signaling comprises configuration information of the second serving cell.

In one embodiment, the first transceiver 1402A selects a first target cell as a response to the determined failure of the handover of the second serving cell, configures a third field of the second failure-related message as an identity of the first target cell, and transmits a fifth signaling; herein, the fifth signaling is used for requesting a connection reestablishment, and the first target cell is used for the connection reestablishment.

In one embodiment, the first receiver 1401A, clearing the first failure-related message, and the second failure-related message comprises the first failure-related message.

In one embodiment, the first transceiver 1402A comprises a receiver.

In one embodiment, the first transceiver 1402A comprises a transmitter.

In one embodiment, the first receiver 1401A comprises the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1401A comprises the antenna 452, the receiver 454, the multi-antenna receiving processor 458 and the receiving processor 456 in FIG. 4 of the present disclosure.

In one embodiment, the first receiver 1401A comprises the antenna 452, the receiver 454 and the receiving processor 456 in FIG. 4 of the present disclosure.

In one embodiment, the first transceiver 1402A comprises the antenna 452, the transmitter 454, the multi-antenna transmitting processor 457, the transmitting processor 468, the controller/processor 459, the memory 460 and the data source 467, the receiver 454, the multi-antenna receiving processor 458 and the receiving processor 456 in FIG. 4 of the present disclosure.

In one embodiment, the first transceiver 1402A comprises the antenna 452, the transmitter 454, the multi-antenna transmitting processor 457, the transmitting processor 468, the receiver 454, the multi-antenna receiving processor 458 and the receiving processor 456 in FIG. 4 of the present disclosure.

In one embodiment, the first transceiver 1402A comprises the antenna 452, the transmitter 454, the transmitting processor 468, the receiver 454 and the receiving processor 456 in FIG. 4 of the present disclosure.

### Embodiment 14B

Embodiment 14B illustrates a structure block diagram of a processing device in first second node according to one embodiment of the present disclosure; as shown in FIG. 14B. In FIG. 14B, a processing device 1400B in a first node comprises a first receiver 1401B and a first transmitter 1402B.

The first receiver 1401B receives a first signaling, the first signaling indicating a first candidate cell set; determines a radio connection failure; and as a response to the determined radio connection failure, generates a first variant set and selects a first target cell.

The first transmitter 1402B configures a first sub-message in the first variant set as an identity of the first target cell; when the first target cell belongs to the first candidate cell set, configures a type of the first target cell in the first variant set as a first type, and transmits a second signaling; when the first target cell is not a candidate cell in the first candidate cell set, configures the type of the first target cell in the first variant set as a second type, and transmits a third signaling.

In Embodiment 14B, the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, a name of the first sub-message in the first variant set is used for determining the type of the first target cell in the first variant set.

In one embodiment, the first variant set comprises a second sub-message, the second sub-message being used to indicate the type of the first target cell in the first variant set.

In one embodiment, the first receiver 1401B receives a second message; the first transmitter 1402B transmits a third information set; herein, the second message is used for requesting the RLF-related message;

the third information set comprises a first sub-information-block, the first sub-information-block is related to the RLF-related message, and the first sub-information-block comprises a value of the first variant set.

In one embodiment, when the first target cell is not a candidate cell in the first candidate cell set, the first receiver 1401B receives a fourth signaling; the first transmitter 1402B transmits a fifth signaling; herein, the fourth signaling is used for triggering the fifth signaling, the fifth signaling comprising the first message.

In one embodiment, the first signaling comprises a first indication symbol and a first configuration, the first indication symbol being used to indicate whether the first node is allowed to apply the first configuration; the first configuration is related to the reconfiguration of the radio resource control connection.

In one embodiment, when the first target cell belongs to the first candidate cell set, a third sub-message in the first variant set is configured as a first condition, the first condition being used to determine conditions for application of the first configuration, and the first signaling indicates the first condition.

In one embodiment, the first receiver 1401B comprises the antenna 452, the receiver 454, the multi-antenna receiving processor 458, the receiving processor 456, the controller/processor 459, the memory 460 and the data source 467 in FIG. 4 of the present disclosure.

In one embodiment, the first receiver 1401B comprises the antenna 452, the receiver 454, the multi-antenna receiving processor 458 and the receiving processor 456 in FIG. 4 of the present disclosure.

In one embodiment, the first receiver 1401B comprises the antenna 452, the receiver 454 and the receiving processor 456 in FIG. 4 of the present disclosure.

In one embodiment, the first transmitter 1402B comprises the antenna 452, the transmitter 454, the multi-antenna transmitting processor 457, the transmitting processor 468, the controller/processor 459, the memory 460 and the data source 467 in FIG. 4 of the present disclosure.

In one embodiment, the first transmitter 1402B comprises the antenna 452, the transmitter 454, the multi-antenna transmitting processor 457 and the transmitting processor 468 in FIG. 4 of the present disclosure.

In one embodiment, the first transmitter 1402B comprises the antenna 452, the transmitter 454 and the transmitting processor 468 in FIG. 4 of the present disclosure.

### Embodiment 15A

Embodiment 15A illustrates a structure block diagram of a processing device in a second node according to one embodiment of the present disclosure; as shown in FIG. 15A. In FIG. 15A, a processing device 1500A in a second node comprises a first transmitter 1501A and a second receiver 1502A.

The first transmitter 1501A transmits a first signaling.

The second receiver 1502A receives a second signaling.

In Embodiment 15A, as a response to determining a failure of the radio connection with the first serving cell, a first failure-related message is generated and the second serving cell is selected; as a response to determining a failure of a handover of the second serving cell, a second failure-related message is generated; the first signaling is transmitted after the second failure-related message is generated, the first signaling is used for triggering the second signaling, the second signaling comprising the second failure-related message; the first failure-related message comprises a first field, and the first field comprised by the first failure-related message comprises an identity of the first serving cell; a second field of the second failure-related message comprises an identity of the first serving cell; the first field of the second failure-related message comprises an identity of the second serving cell; a connection failure type field of the first failure-related message is a first type, and the connection failure type field of the second failure-related message is a second type.

In one embodiment, the second signaling comprises the first failure-related message.

In one embodiment, the second receiver 1502A receives a third signaling; herein, the third signaling comprises a first message, the first message being used for indicating that the first failure-related message and the second failure-related message are generated.

In one embodiment, the first signaling indicates a message to be reported, and the second signaling comprises the message to be reported, the message to be reported comprising at least one of the first failure-related message or the second failure-related message.

In one embodiment, a fourth signaling comprises configuration information of the second serving cell, and a transmitter of the fourth signaling comprises the first serving cell.

In one embodiment, the second receiver 1502A receives a fifth signaling; herein, the fifth signaling is used for requesting a connection reestablishment; as a response to determining the failure of the handover of the second serving cell, a first target cell is selected, and the first target cell is used for the connection reestablishment, and a third field of the second failure-related message is configured as an identity of the first target cell.

In one embodiment, the first failure-related message is cleared, and the second failure-related message comprises the first failure-related message.

In one embodiment, the first transmitter 1501A comprises the antenna 420, the transmitter 418, the multi-antenna transmitting processor 471, the transmitting processor 416, the controller/processor 475 and the memory 476 in FIG. 4 of the present disclosure.

In one embodiment, the first transmitter 1501A comprises the antenna 420, the transmitter 418, the multi-antenna transmitting processor 471 and the transmitting processor 416 in FIG. 4 of the present disclosure.

In one embodiment, the first transmitter 1501A comprises the antenna 420, the transmitter 418 and the transmitting processor 416 in FIG. 4 of the present disclosure.

In one embodiment, the second receiver 1502A comprises the antenna 420, the receiver 418, the multi-antenna receiving processor 472, the receiving processor 470, the controller/processor 475 and the memory 476 in FIG. 4 of the present disclosure.

In one embodiment, the second receiver 1502A comprises the antenna 420, the receiver 418, the multi-antenna receiving processor 472 and the receiving processor 470 in FIG. 4 of the present disclosure.

In one embodiment, the second receiver 1502A comprises the antenna 420, the receiver 418 and the receiving processor 470 in FIG. 4 of the present disclosure.

### Embodiment 15B

Embodiment 15B illustrates a structure block diagram of a processing device in a second node according to one embodiment of the present disclosure; as shown in FIG. 15B. In FIG. 15B, a processing device 1500B in a second node comprises a second transmitter 1501B and a second receiver 1502B.

The second receiver 1502B configures a first sub-message in a first variant set as an identity of a first target cell; when the first target cell belongs to a first candidate cell set, configures a type of the first target cell in the first variant set as a first type, and receiving a second signaling; when the first target cell is not a candidate cell in the first candidate cell set, configures a type of the first target cell in the first variant set as a second type, and receives a third signaling.

In Embodiment 15B, the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

In one embodiment, a name of the first sub-message in the first variant set is used for determining the type of the first target cell in the first variant set.

In one embodiment, the first variant set comprises a second sub-message, the second sub-message being used to indicate the type of the first target cell in the first variant set.

In one embodiment, the second transmitter 1501B transmits a second message; and the second receiver 1502B receives a third information set; herein, the second message is used for requesting the RLF-related message; the third information set comprises a first sub-information-block, the first sub-information-block is related to the RLF-related message, and the first sub-information-block comprises a value of the first variant set.

In one embodiment, when the first target cell is not a candidate cell in the first candidate cell set, the second transmitter 1501B transmits a fourth signaling; the second receiver 1502B receives a fifth signaling; herein, the fourth signaling is used for triggering the fifth signaling, the fifth signaling comprising the first message.

In one embodiment, the first signaling comprises a first indication symbol and a first configuration, the first indication symbol being used to indicate whether the first node is allowed to apply the first configuration; the first configuration is related to the reconfiguration of the radio resource control connection.

In one embodiment, when the first target cell belongs to the first candidate cell set, a third sub-message in the first variant set is configured as a first condition, the first condition being used to determine conditions for application of the first configuration, and the first signaling indicates the first condition.

In one embodiment, the second transmitter 1501B comprises the antenna 420, the transmitter 418, the multi-antenna transmitting processor 471, the transmitting processor 416, the controller/processor 475 and the memory 476 in FIG. 4 of the present disclosure.

In one embodiment, the second transmitter 1501B comprises the antenna 420, the transmitter 418, the multi-antenna transmitting processor 471 and the transmitting processor 416 in FIG. 4 of the present disclosure.

In one embodiment, the second transmitter 1501B comprises the antenna 420, the transmitter 418 and the transmitting processor 416 in FIG. 4 of the present disclosure.

In one embodiment, the second receiver 1502B comprises the antenna 420, the receiver 418, the multi-antenna receiving processor 472, the receiving processor 470, the controller/processor 475 and the memory 476 in FIG. 4 of the present disclosure.

In one embodiment, the second receiver 1502B comprises the antenna 420, the receiver 418, the multi-antenna receiving processor 472 and the receiving processor 470 in FIG. 4 of the present disclosure.

In one embodiment, the second receiver 1502B comprises the antenna 420, the receiver 418 and the receiving processor 470 in FIG. 4 of the present disclosure.

The ordinary skill in the art may understand that all or part of steps in the above method may be implemented by instructing related hardware through a program. The program may be stored in a computer readable storage medium, for example Read-Only-Memory (ROM), hard disk or compact disc, etc.

Optionally, all or part of steps in the above embodiments also may be implemented by one or more integrated circuits. Correspondingly, each module unit in the above embodiment may be implemented in the form of hardware, or in the form of software function modules. The present disclosure is not limited to any combination of hardware and software in specific forms. The UE and terminal in the present disclosure include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (JOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present disclosure includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, receiving a first signaling, the first signaling indicating a first candidate cell set; determining a radio connection failure; and as a response to the determined radio connection failure, generating a first variant set and selecting a first target cell;
a first transmitter, configuring a first sub-message in the first variant set as an identity of the first target cell; when the first target cell belongs to the first candidate cell set, configuring a type of the first target cell in the first variant set as a first type, and transmitting a second signaling; when the first target cell is not a candidate cell in the first candidate cell set, configuring the type of the first target cell in the first variant set as a second type, and transmitting a third signaling;
wherein the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

2. The first node according to claim 1, a name of the first sub-message in the first variant set is used for determining the type of the first target cell in the first variant set.

3. The first node according to claim 1, the first variant set comprises a second sub-message, the second sub-message being used to indicate the type of the first target cell in the first variant set.

4. The first node according to claim 1, comprising:
the first receiver, receiving a second message;
the first transmitter, transmitting a third information set;
wherein the second message is used for requesting the RLF-related message; the third information set comprises a first sub-information-block, the first sub-information-block is related to the RLF-related message, and the first sub-information-block comprises a value of the first variant set.

5. The first node according to claim 1, comprising:
the first receiver, when the first target cell is not a candidate cell in the first candidate cell set, receiving a fourth signaling;
the first transmitter, transmitting a fifth signaling;
wherein the fourth signaling is used for triggering the fifth signaling, the fifth signaling comprising the first message.

6. The first node according to claim 1, the first signaling comprises a first indication symbol and a first configuration, the first indication symbol being used to indicate whether the first node is allowed to apply the first configuration; the first configuration is related to the reconfiguration of the radio resource control connection.

7. The first node according to claim 6, when the first target cell belongs to the first candidate cell set, a third sub-message in the first variant set is configured as a first condition, the first condition being used to determine conditions for application of the first configuration, and the first signaling indicates the first condition.

8. The first node according to claim 1, the first variant set comprises a VarRLF-Report; the first sub-message comprising a first sub-field and a second sub-field; the first sub-field is a field in a VarRLF-Report; the second sub-field is a field in a VarRLF-Report; the first sub-field is used to indicate that a type of the first target cell is a first type; the second sub-field is used to indicate that a type of the first target cell is a second type.

9. The first node according to claim 8, the first sub-field comprises the first name; the first name indicates that the first target cell is related to the first type; the second sub-field comprises the second name; the second name indicates that the first target cell is related to the second type.

10. The first node according to claim 9, the first name indicates that the first target cell is related to CHO; the second name indicates that the first target cell is related to RRC Connection Reestablishment.

11. The first node according to claim 8, when the first target cell belongs to the first candidate cell set, the first sub-field is configured as the identity of the first target cell.

12. The first node according to claim 8, when the first target cell is not a candidate cell in the first candidate cell set, a name of the second sub-field is configured as the identity of the first target cell.

13. The first node according to claim 8, the first sub-field and the second sub-field are not configured at the same time.

14. The first node according to claim 1, the radio connection failure comprises an RLF, or the radio connection failure comprises a Handover Failure.

15. The first node according to claim 1, the identity of the first target cell includes a global cell identity of the first target cell, or the identity of the first target cell includes a physical cell identity of the first target cell.

16. The first node according to claim 1, when the timer T310 is expired, the first node determines a radio connection failure; wherein, the T310 is for a first serving cell, or when the timer T312 is expired, the first node determines a radio connection failure; wherein, the T312 is for a first serving cell, or when an indication of reaching a maximum number of retransmissions is received from MCG RLC, the first node determines a radio connection failure, or when receiving an indication of an issue of random access from MCG MAC, and none of the timers T300, T301, T304, T311 and T319 is running, the first node determines a radio connection failure.

17. The first node according to claim 1, the phrase of generating a first variant set includes the meaning that if the first variant set stores content, it shall first clear the content of the first variant set and then store the RLF-related message.

18. A method in a first node for wireless communications, comprising:
receiving a first signaling, the first signaling indicating a first candidate cell set; determining a radio connection failure; and as a response to the determined radio connection failure, generating a first variant set and selecting a first target cell;
configuring a first sub-message in the first variant set as an identity of the first target cell; when the first target cell belongs to the first candidate cell set, configuring a type of the first target cell in the first variant set as a first type, and transmitting a second signaling; when the first target cell is not a candidate cell in the first candidate cell set, configuring the type of the first target cell in the first variant set as a second type, and transmitting a third signaling;
wherein the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

19. A second node for wireless communications, comprising:
a second receiver, configuring a first sub-message in a first variant set as an identity of a first target cell; when the first target cell belongs to a first candidate cell set, configuring a type of the first target cell in the first variant set as a first type, and receiving a second signaling; when the first target cell is not a candidate cell in the first candidate cell set, configuring a type of the first target cell in the first variant set as a second type, and receiving a third signaling;
wherein the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.

20. A method in a second node for wireless communications, comprising:
configuring a first sub-message in a first variant set as an identity of a first target cell; when the first target cell belongs to a first candidate cell set, configuring a type of the first target cell in the first variant set as a first type, and receiving a second signaling; when the first target cell is not a candidate cell in the first candidate cell set, configuring a type of the first target cell in the first variant set as a second type, and receiving a third signaling;
wherein the first candidate cell set is indicated by a first signaling; as a response to determining a radio connection failure, a first variant set is generated and a first target cell is selected; the first variant set is related to an RLF-related message; the second signaling is used to determine that reconfiguration of a radio resource control connection is successful, and the second signaling comprises a first message; the third signaling is used to request reestablishment of the radio resource control connection, and the third signaling does not comprise the first message; the first message is used to determine whether there is the RLF-related message.
